(19) United States
(12) Patent Application Publication
(10) Pub. No.: US 2019/0089472 A1
(43) Pub. Date: Mar. 21, 2019

(54) AUDIO SYNCHRONIZATION OVER WLAN

(71) Applicant: QUALCOMM Incorporated, San Diego, CA (US)

(72) Inventors: Xiaoxin ZHANG, Sunnyvale, CA (US); James Simon CHO, Mountain View, CA (US)

(21) Appl. No.: 16/133,632

(22) Filed: Sep. 17, 2018

Related U.S. Application Data
(60) Provisional application No. 62/560,141, filed on Sep. 18, 2017.

(51) Int. Cl. H04J 3/06; H04W 56/00; H04B 7/26

(52) U.S. Cl. CPC H04J 3/0667; H04W 84/12; H04B 7/2643; H04W 56/001

(57) ABSTRACT

Devices and methods for wireless communication are disclosed. A method includes a wireless station receiving a first packet that includes a first media payload and a first media timestamp from a second device. The method includes the station capturing a time of arrival (TOA) timestamp in response to receiving the first packet from the second device. The TOA timestamp is sampled using a device clock of the station. The method includes the station receiving a second packet that includes a second media payload and a second media timestamp from the second device. A time of departure (TOD) timestamp associated with a transmission time of the first packet is embedded in the second packet. The TOD timestamp is sampled using a system clock of the second device. The method includes the station synchronizing its device clock to the system clock of the second device based on the TOA and TOD timestamps.

### CROSS-REFERENCE TO RELATED APPLICATION(S)

This application claims the priority benefit of U.S. Provisional Application Ser. No. 62/560,141, entitled “AUDIO SYNCHRONIZATION OVER WLAN” and filed on Sep. 18, 2017, which is expressly incorporated by reference herein in its entirety.

### TECHNICAL FIELD

This disclosure relates generally to wireless communications, and more specifically, to the synchronization of clocks in different devices within a wireless network.

### DESCRIPTION OF THE RELATED TECHNOLOGY

A wireless local area network (WLAN) may be formed by one or more access points (APs) that provide a shared wireless communication medium for use by a number of client devices also referred to as stations (STAs). The basic building block of a WLAN conforming to the 802.11 family of standards is a Basic Service Set (BSS), which is managed by an AP. Each BSS is identified by a service set identifier (SSID) that is advertised by the AP. An AP periodically broadcasts beacon frames to enable any STAs within wireless range of the AP to establish and/or maintain a communication link with the WLAN. In a typical WLAN, each STA may be associated with only one AP at a time. To identify an AP with which to associate, a STA is configured to perform scans on the wireless channels of each of one or more frequency bands (for example, the 2.4 GHz band and/or the 5 GHz band). As a result of the increasing ubiquity of wireless networks, a STA may have the opportunity to select one of many WLANs within range of the STA and/or select among multiple APs that together form an extended BSS. After association with an AP, a STA also may be configured to periodically scan its surroundings to find a more suitable AP with which to associate. For example, a STA that is moving relative to its associated AP may perform a “roaming” scan to find an AP having more desirable network characteristics such as a greater received signal strength indicator (RSSI).

Wireless communications systems are widely deployed to provide various types of communication content such as voice, video, packet data, messaging, broadcast, and so on. These systems may be multiple-access systems capable of supporting communication with multiple users by sharing the available system resources (for example, time, frequency, and space). The AP may be coupled to a network, such as the Internet, and may enable a station to communicate via the network including communicating with other devices coupled to the AP.

### SUMMARY

The systems, methods and devices of this disclosure each have several innovative aspects, no single one of which is solely responsible for the desirable attributes disclosed herein.

One innovative aspect of the subject matter described in this disclosure can be implemented in a method for wireless communication. In some implementations, the method includes transmitting a first packet from a first device to a second device, capturing a first time of departure (TOD) timestamp for the first packet, embedding the first TOD timestamp in a second packet, and transmitting the second packet from the first device to the second device.

In other implementations, the method includes receiving a first packet at a first device from a second device, capturing a first time of arrival (TOA) timestamp in response to the receiving of the first packet, and receiving a second packet at the first device from the second device into which a first TOD timestamp is embedded.

Another innovative aspect of the subject matter described in this disclosure can be implemented in an apparatus. In some implementations, the apparatus includes means for transmitting a first packet from the first device to a second device, means for capturing a first TOD timestamp for the first packet, means for embedding the first TOD timestamp in a second packet, and means for transmitting the second packet from the first device to the second device.

In other implementation, the apparatus includes means for receiving a first packet at a first device from a second device, means for capturing a first TOA timestamp in response to the receiving of the first packet at the first device from the second device, and means for receiving a second packet at the first device from the second device. The first TOD timestamp is embedded in the second packet

Another innovative aspect of the subject matter described in this disclosure can be implemented in a wireless communications device. The wireless communications device includes at least one antenna, a processor, and a memory communicatively coupled with the processor and storing processor-readable code that, when executed by the processor, causes the wireless communications device to receive a first packet at a first device from a second device, capture a first TOA timestamp in response to the receiving of the first packet at the first device from the second device, and receive a second packet at the first device from the second device, wherein a first TOD timestamp is embedded in the second packet.

Another innovative aspect of the subject matter described in this disclosure can be implemented in a wireless access point. The wireless access point includes at least one antenna, a processor, and a memory communicatively coupled with the processor and storing processor-readable code that, when executed by the processor, causes the wireless access point to transmit a first packet from the first device to a second device, capture a first time of TOD timestamp for the first packet, embed the first TOD timestamp in a second packet, and transmit the second packet from the first device to the second device. The first TOD timestamp is embedded in the second packet.

Details of one or more implementations of the subject matter described in this disclosure are set forth in the accompanying drawings and the description below. Other features, aspects, and advantages will become apparent from the description, the drawings and the claims. Note that the relative dimensions of the following figures may not be drawn to scale.

### BRIEF DESCRIPTION OF THE DRAWINGS

FIG. 1 shows a block diagram of an example wireless communication system.

FIG. 2A shows an example frame usable for communications between an access point (AP) and a number of stations (STAs).

FIG. 2B shows an example frame usable for communications between an AP and a number of STAs.

FIG. 3 shows a block diagram of an example AP for use in wireless communication.

FIG. 4 shows a block diagram of an example STA for use in wireless communication.

FIG. 5 illustrates an example operational diagram of a wireless local area network (WLAN) operating in an azimuth mode to synchronize clocks in the AP and the STAs of the WLAN network.

FIG. 6 illustrates an example operational diagram of a WLAN operating in a non-promiscuous mode to synchronize clocks in the AP and the STAs of the WLAN.

FIG. 7 illustrates an example operational diagram of a WLAN operating in a promiscuous mode to synchronize clocks in the AP and the STAs of the WLAN.

FIG. 8 illustrates another example operational diagram of a WLAN operating in a promiscuous mode to synchronize clocks in the AP and the STAs of the WLAN.

FIG. 9 illustrates yet another example operational diagram of a WLAN operating in a promiscuous mode to synchronize clocks in the AP and the STAs of the WLAN.

FIG. 10 illustrate a hardware (HW) capture circuit that captures a media timestamp and a packet timestamp.

FIG. 11 shows a flowchart illustrating an example process for wireless communication according to some implementations.

FIG. 12 shows a flowchart illustrating an example process for wireless communication according to some implementations.

Like reference numbers and designations in the various drawings indicate like elements.

### DETAILED DESCRIPTION

The following description is directed to certain implementations for the purposes of describing innovative aspects of this disclosure. However, a person having ordinary skill in the art will readily recognize that the teachings herein can be applied in a multitude of different ways. The described implementations can be implemented in any device, system or network that is capable of transmitting and receiving radio frequency (RF) signals according to any of the IEEE 802.11 standards, or the Bluetooth® standards. The described implementations also can be implemented in any device, system or network that is capable of transmitting and receiving RF signals according to any of the following technologies or techniques: code division multiple access (CDMA), frequency division multiple access (FDMA), orthogonal frequency division multiple access (OFDMA), time division multiple access (TDMA), Global System for Mobile communications (GSM), GSM/General Packet Radio Service (GPRS), Enhanced Data GSM Environment (EDGE), Terrestrial Trunked Radio (TETRA), Wideband-CDMA (W-CDMA), Evolution Data Optimized (EV-DO), 1×EV-DO, EV-DO Rev A, EV-DO Rev B, High Speed Packet Access (HSPA), High Speed Downlink Packet Access (HSDPA), High Speed Uplink Packet Access (HSUPA), Evolved High Speed Packet Access (HSPA+), Long Term Evolution (LTE), AMPS, or other known signals that are used to communicate within a wireless, cellular or internet of things (IOT) network, such as a system utilizing 3G, 4G or 5G, or further implementations thereof, technology.

Various implementations relate generally to wireless communication networks. Some implementations more specifically relate to wireless local area networks (WLANs). Particular implementations of the subject matter described in this disclosure can be implemented to realize one or more of the following potential advantages. In some implementations, the described techniques can be used to synchronize clocks in different devices within a WLAN.

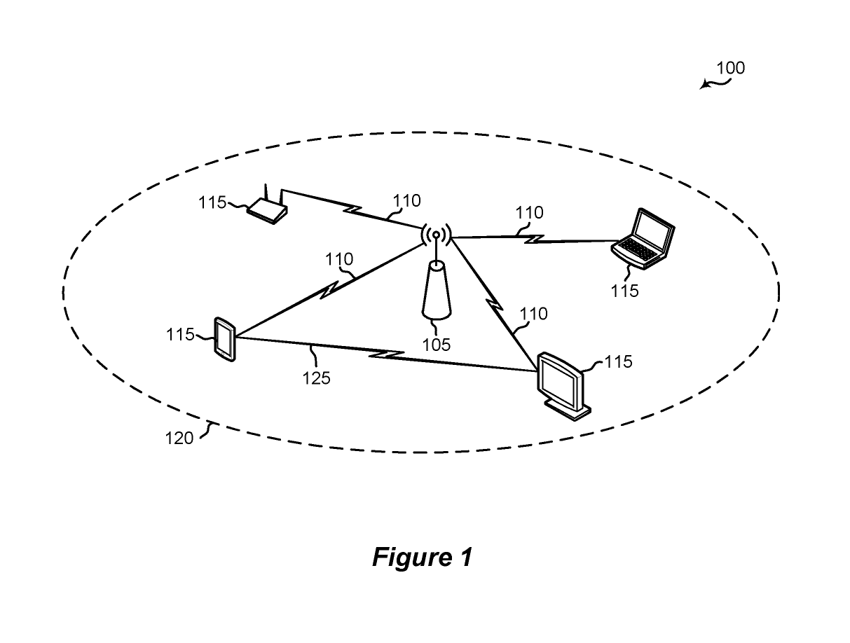

FIG. 1 shows a block diagram of an example wireless communication system 100. According to some aspects, the wireless communication system 100 can be an example of a WLAN (and will hereinafter be referred to as WLAN 100). For example, the WLAN 100 can be a network implementing at least one of the IEEE 802.11 family of standards. The WLAN 100 may include numerous wireless devices such as an access point (AP) 105 and multiple associated stations (STAs) 115. Each of the STAs 115 also may be referred to as a mobile station (MS), a mobile device, a mobile handset, a wireless handset, an access terminal (AT), a user equipment (UE), a subscriber station (SS), or a subscriber unit, among other possibilities. The STAs 115 may represent various devices such as mobile phones, personal digital assistant (PDAs), other handheld devices, netbooks, notebook computers, tablet computers, laptops, display devices (for example, TVs, computer monitors, navigation systems, among others), wireless speakers, printers, key fobs (for example, for passive keyless entry and start (PKES) systems), among other possibilities.

Each of the STAs 115 may associate and communicate with the AP 105 via a communication link 110. The various STAs 115 in the network are able to communicate with one another through the AP 105. A single AP 105 and an associated set of STAs 115 may be referred to as a basic service set (BSS). FIG. 1 additionally shows an example coverage area 120 of the AP 105, which may represent a basic service area (BSA) of the WLAN 100. While only one AP 105 is shown, the WLAN network 100 can include multiple APs 105. An extended service set (ESS) may include a set of connected BSSs. An extended network station associated with the WLAN 100 may be connected to a wired or wireless distribution system that may allow multiple APs 105 to be connected in such an ESS. As such, a STA 115 can be covered by more than one AP 105 and can associate with different APs 105 at different times for different transmissions.

STAs 115 may function and communicate (via the respective communication links 110) according to the IEEE 802.11 family of standards and amendments including, but not limited to, 802.11a, 802.11b, 802.11g, 802.11n, 802.11ac, 802.11ad, 802.11ah, 802.11ay, 802.11ax, 802.11az, and 802.11ba. These standards define the WLAN radio and baseband protocols for the PHY and medium access control (MAC) layers. The wireless devices in the WLAN 100 may communicate over an unlicensed spectrum, which may be a portion of spectrum that includes frequency bands traditionally used by Wi-Fi technology, such as the 2.4 GHz band, the 5 GHz band, the 60 GHz band, the 3.6 GHz band, and the 900 MHz band. The unlicensed spectrum may also include other frequency bands, such as the emerging 6 GHz band. The wireless devices in the WLAN 100 also can be configured to communicate over other frequency bands such as shared licensed frequency bands, where multiple operators may have a license to operate in the same or overlapping frequency band or bands.

In some cases, STAs 115 may form networks without APs 105 or other equipment other than the STAs 115 themselves. One example of such a network is an ad hoc network (or wireless ad hoc network). Ad hoc networks may alternatively be referred to as mesh networks or peer-to-peer (P2P) connections. In some cases, ad hoc networks may be implemented within a larger wireless network such as the WLAN 100. In such implementations, while the STAs 115 may be capable of communicating with each other through the AP 105 using communication links 110, STAs 115 also can communicate directly with each other via direct wireless communication links 125. Additionally, two STAs 115 may communicate via a direct communication link 125 regardless of whether both STAs 115 are associated with and served by the same AP 105. In such an ad hoc system, one or more of the STAs 115 may assume the role filled by the AP 105 in a BSS. Such a STA 115 may be referred to as a group owner (GO) and may coordinate transmissions within the ad hoc network. Examples of direct wireless communication links 125 include Wi-Fi Direct connections, connections established by using a Wi-Fi Tunneled Direct Link Setup (TDLS) link, and other peer-to-peer (P2P) group connections.

Some types of STAs 115 may provide for automated communication. Automated wireless devices may include those implementing internet-of-things (IoT) communication, Machine-to-Machine (M2M) communication, or machine type communication (MTC). IoT, M2M or MTC may refer to data communication technologies that allow devices to communicate without human intervention. For example, IoT, M2M or MTC may refer to communications from STAs 115 that integrate sensors or meters to measure or capture information and relay that information to a central server or application program that can make use of the information or present the information to humans interacting with the program or application.

Some of STAs 115 may be MTC devices, such as MTC devices designed to collect information or enable automated behavior of machines. Examples of applications for MTC devices include smart metering, inventory monitoring, water level monitoring, equipment monitoring, healthcare monitoring, wildlife monitoring, weather and geological event monitoring, fleet management and tracking, remote security sensing, physical access control, and transaction-based business charging. An MTC device may operate using half-duplex (one-way) communications at a reduced peak rate. MTC devices may also be configured to enter a power saving “deep sleep” mode when not engaging in active communications.

WLAN 100 may support beamformed transmissions. As an example, AP 105 may use multiple antennas or antenna arrays to conduct beamforming operations for directional communications with a STA 115. Beamforming (which may also be referred to as spatial filtering or directional transmission) is a signal processing technique that may be used at a transmitter (e.g., AP 105) to shape and/or steer an overall antenna beam in the direction of a target receiver (e.g., a STA 115). Beamforming may be achieved by combining elements in an antenna array in such a way that transmitted signals at particular angles experience constructive interference while others experience destructive interference. In some cases, the ways in which the elements of the antenna array are combined at the transmitter may depend on channel state information (CSI) associated with the channels over which the AP 105 may communicate with the STA 115. That is, based on this CSI, the AP 105 may appropriately weight the transmissions from each antenna (e.g., or antenna port) such that the desired beamforming effects are achieved. In some cases, these weights may be determined before beamforming can be employed. For example, the transmitter (e.g., the AP 105) may transmit one or more sounding packets to the receiver in order to determine CSI.

WLAN 100 may further support multiple-input, multiple-output (MIMO) wireless systems. Such systems may use a transmission scheme between a transmitter (e.g., AP 105) and a receiver (e.g., a STA 115), where both transmitter and receiver are equipped with multiple antennas. For example, AP 105 may have an antenna array with a number of rows and columns of antenna ports that the AP 105 may use for beamforming in its communication with a STA 115. Signals may be transmitted multiple times in different directions (e.g., each transmission may be beamformed differently). The receiver (e.g., STA 115) may try multiple beams (e.g., antenna subarrays) while receiving the signals.

WLAN PDUs may be transmitted over a radio frequency spectrum band, which in some examples may include multiple sub-bands or frequency channels. In some cases, the radio frequency spectrum band may have a bandwidth of 80 MHz, and each of the sub-bands or channels may have a bandwidth of 20 MHz. Transmissions to and from STAs 115 and APs 105 typically include control information within a header that is transmitted prior to data transmissions. The information provided in a header is used by a receiving device to decode the subsequent data. A legacy WLAN preamble may include legacy short training field (STF) (L-STF) information, legacy LTF (L-LTF) information, and legacy signaling (L-SIG) information. The legacy preamble may be used for packet detection, automatic gain control and channel estimation, among other uses. The legacy preamble may also be used to maintain compatibility with legacy devices.

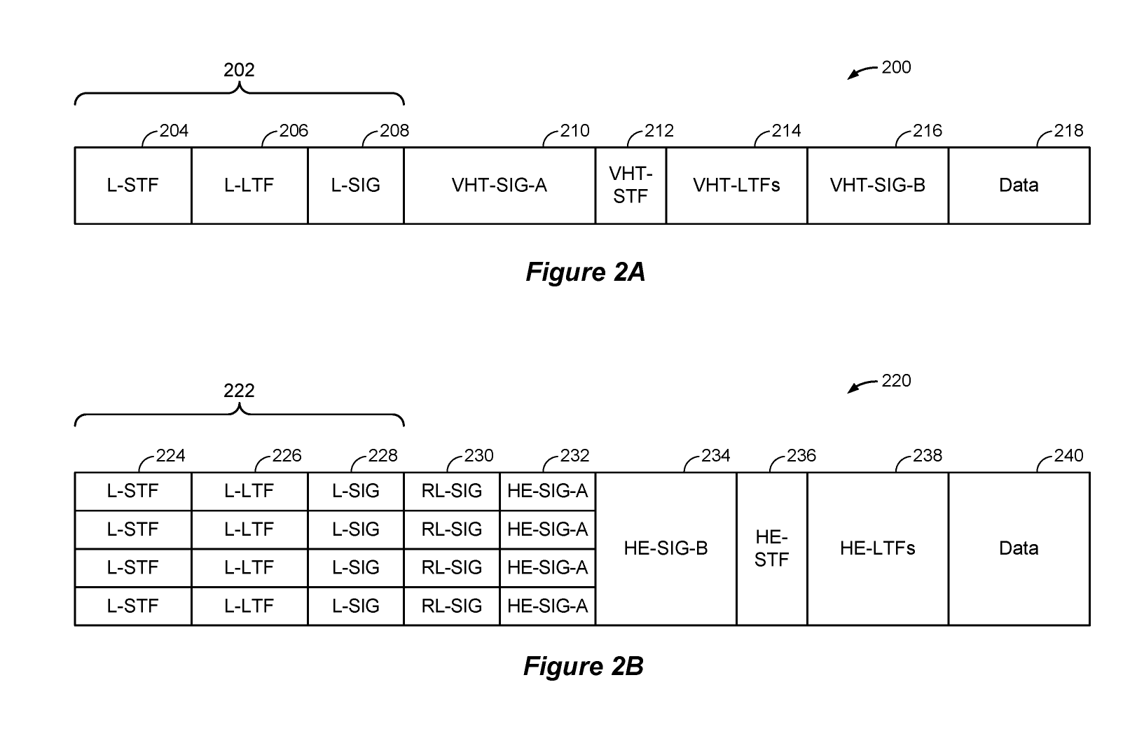

FIG. 2A shows an example frame 200 usable for communications between an AP and each of a number of stations identified by the AP. For example, the frame 200 can be formatted as a very high throughput (VHT) frame in accordance with the IEEE 802.11ac amendment to the IEEE 802.11 set of standards. The frame 200 includes a legacy preamble portion 202 that includes a legacy short training field (L-STF) 204, a legacy long training field (L-LTF) 206, and a legacy signaling field (L-SIG) 208. The frame 200 further includes a non-legacy preamble portion that includes a first very high throughput (VHT) signaling field (VHT-SIG-A) 210, a VHT short training field (VHT-STF) 212, a number of VHT long training fields (VHT-LTFs) 214 and a second VHT signaling field (VHT-SIG-B) 216. The frame 200 also can include a payload or data portion 218 after the preamble. The data portion 218 can include medium access control (MAC) protocol data units (MPDUs), for example, in the form of an aggregated MPDU (AMPDU).

The frame 200 may be transmitted over a radio frequency spectrum band, which may include a plurality of sub-bands. For example, the radio frequency spectrum band may have a bandwidth of 80 MHz, and each of the sub-bands may have a bandwidth of 20 MHz. When the radio frequency spectrum band includes a plurality of sub-bands, the L-STF, L-LTF, and L-SIG fields 204, 206 and 208, respectively, may be duplicated and transmitted in each of the plurality of sub-bands. The information in the VHT-SIG-A field 210 is also duplicated and transmitted in each sub-band.

The VHT-SIG-A field 210 may indicate to a station that the frame 200 is an IEEE 802.11ac frame. The VHT-SIG-A field 210 also may include VHT WLAN signaling information usable by stations other than the number of stations that are identified to receive downlink communications in the frame 200. The VHT-SIG-A field 210 also includes information usable by the identified number of stations to decode the VHT-SIG-B field 216. The VHT-SIG-B field 216 may include VHT WLAN signaling information usable by the number of stations identified to receive downlink communications in the frame 200. More specifically, the VHT-SIG-B field 216 may include information usable by the number of stations to decode data received in the data portion 218. The VHT-SIG-B field 216 may be encoded separately from the VHT-SIG-A field 210. The number of VHT-LTFs 214 depends on the number of transmitted streams.

FIG. 2B shows an example frame 220 usable for communications between an AP and each of a number of stations identified by the AP. For example, the frame 220 can be formatted as a high efficiency (HE) frame in accordance with the IEEE 802.11ax amendment to the IEEE 802.11 set of standards. The frame 220 includes a legacy preamble portion 222 that includes a legacy short training field (L-STF) 224, a legacy long training field (L-LTF) 226, and a legacy signaling field (L-SIG) 228. The frame 220 further includes a non-legacy preamble portion that includes a repeated legacy signaling field (RL-SIG) 230, a first high efficiency signaling field (HE-SIG-A) 232, a second high efficiency signaling field (HE-SIG-B) 234, a high efficiency short training field (HE-STF) 236 and a number of high efficiency long training fields (HE-LTFs) 238. The frame 220 also can include a payload or data portion 240 after the preamble. The data portion 240 can include medium access control (MAC) protocol data units (MPDUs), for example, in the form of an aggregated MPDU (AMPDU).

The frame 220 may be transmitted over a radio frequency spectrum band, which may include a plurality of sub-bands. For example, the radio frequency spectrum band may have a bandwidth of 80 MHz, and each of the sub-bands may have a bandwidth of 20 MHz. When the radio frequency spectrum band includes a plurality of sub-bands, the L-STF, L-LTF, and L-SIG fields 224, 226 and 228, respectively, may be duplicated and transmitted in each of the plurality of sub-bands. The information in the RL-SIG field 230 and the HE-SIG-A field 232 is also duplicated and transmitted in each sub-band as shown in FIG. 2B.

The RL-SIG field 230 may indicate to a station that the frame 220 is an IEEE 802.11ax frame. The HE-SIG-A field 232 may include high efficiency WLAN signaling information usable by stations other than the number of stations that are identified to receive downlink communications in the frame 220. The HE-SIG-A field 232 may also include information usable by the identified number of stations to decode the HE-SIG-B field 234. The HE-SIG-B field 234 may include high efficiency WLAN signaling information usable by the number of stations identified to receive downlink communications in the frame 220. More specifically, the HE-SIG-B field 234 may include information usable by the number of stations to decode data received in the data portion 240. The HE-SIG-B field 234 may be encoded separately from the HE-SIG-A field 232.

High efficiency (HE) WLAN (HEW) preambles can be used to schedule multiple devices, such as STAs 115, for multi-user simultaneous transmissions (for example, using multi-user orthogonal frequency division multiple access (MU-OFDMA) or multi-user multiple-input, multiple-output (MU-MIMO) techniques). A HEW signaling field may be used to signal a resource allocation pattern to multiple receiving STAs 115. The HEW signaling field can include a common user field that is decodable by multiple STAs 115, as well as a resource allocation field. The resource allocation field can indicate resource unit distributions to multiple STAs 115 and indicate which resource units in a resource unit distribution correspond to MU-MIMO transmissions and which resource units correspond to OFDMA transmissions. The HEW signaling field also can include, subsequent to the common user field, dedicated station-specific signaling fields that are assigned to particular STAs 115 and used to schedule resources and to indicate the scheduling to other WLAN devices.

In some cases, aspects of transmissions may vary based on a distance between a transmitter (for example, AP 105) and a receiver (for example, STA 115). WLAN 100 may otherwise generally benefit from AP 105 having information regarding the location of the various STAs 115 within coverage area 120. In some examples, relevant distances may be computed using RTT-based ranging procedures. As an example, WLAN 100 may offer such functionality that produces accuracy on the order of one meter (or even centimeter-level accuracy). The same (or similar) techniques employed in WLAN 100 may be applied across other radio access technologies (RATs). For example, such RTT-based ranging functionality may be employed in developing “relative geofencing” applications (i.e., applications where there is a geofence relative to an object of interest such as a mobile device, a car, a person, etc.). Various such examples are considered in accordance with aspects of the present disclosure. For example, car keys may employ RTT estimation for PKES systems. RTT-based geofences around an adult may monitor the position of a child within the geofence. Additionally, drone-to-drone and car-to-car RTT functionality may help prevent collisions.

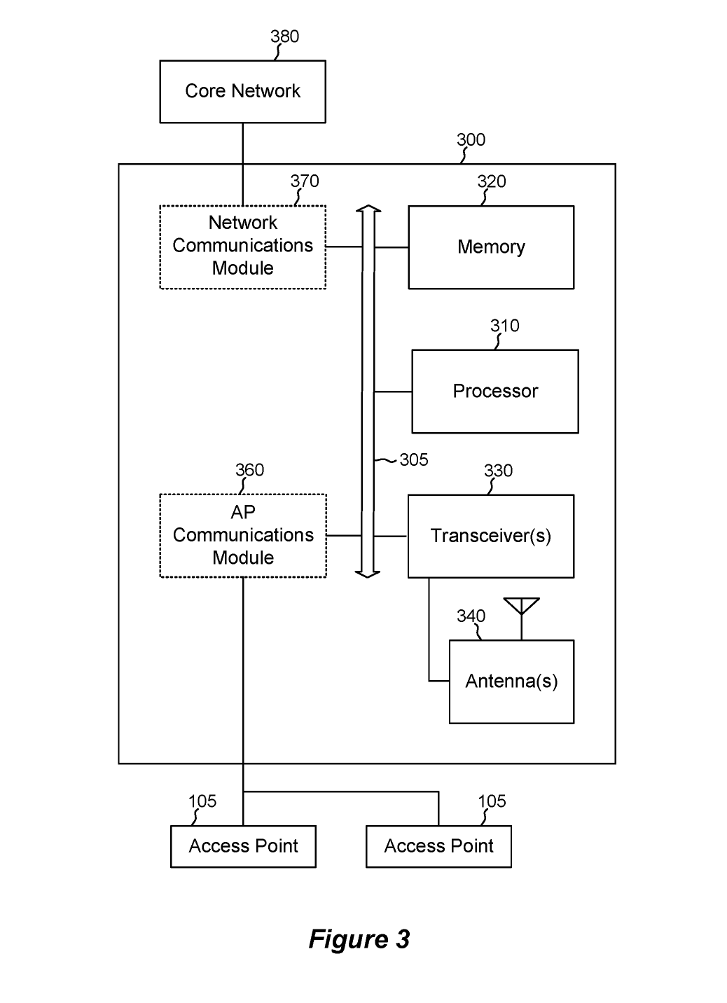

FIG. 3 shows a block diagram of an example access point (AP) 300 for use in wireless communication. For example, the AP 300 may be an example of aspects of the AP 105 described with reference to FIG. 1. The AP 400 can be configured to send and receive WLAN frames (also referred to herein as transmissions or communications) conforming to an IEEE 802.11 standard (such as the 802.11ac or 802.11ax amendments to the 802.11 family of standards), as well as to encode and decode such frames. The AP 300 includes a processor 310, a memory 320, at least one transceiver 330 and at least one antenna 340. In some implementations, the AP 300 also includes one or both of an AP communications module 360 and a network communications module 370. Each of the components (or “modules”) described with reference to FIG. 3 can communicate with one another, directly or indirectly, over at least one bus 305.

The memory 320 can include random access memory (RAM) and read-only memory (ROM). The memory 320 also can store processor- or computer-executable software (SW) code 325 containing instructions that, when executed by the processor 310, cause the processor to perform various functions described herein for wireless communication, including generation and transmission of a downlink frame and reception of an uplink frame.

The processor 310 can include an intelligent hardware device such as, for example, a central processing unit (CPU), a microcontroller, an application-specific integrated circuit (ASIC), or a programmable logic device (PLD) such as a field programmable gate array (FPGA), among other possibilities. The processor 310 processes information received through the transceiver 330, the AP communications module 360, and the network communications module 370. The processor 310 also can process information to be sent to the transceiver 330 for transmission through the antenna 340, information to be sent to the AP communications module 360, and information to be sent to the network communications module 370. The processor 310 can generally be configured to perform various operations related to generating and transmitting a downlink frame and receiving an uplink frame.

The transceiver 330 can include a modem to modulate packets and provide the modulated packets to the antenna 340 for transmission, as well as to demodulate packets received from the antenna 340. The transceiver 330 can be implemented as at least one radio frequency (RF) transmitter and at least one separate RF receiver. The transceiver 330 can communicate bi-directionally, via the antenna 340, with at least one station 115 as, for example, shown in FIG. 1. Although only one transceiver 330 and one antenna 340 are shown in FIG. 3, the AP 300 can typically include multiple transceivers 330 and antennas 340. For example, in some AP implementations, the AP 300 can include multiple transmit antennas (each with a corresponding transmit chain) and multiple receive antennas (each with a corresponding receive chain). The AP 300 may communicate with a core network 380 through the network communications module 370. The system also may communicate with other APs, such as APs 105, using the AP communications module 360.

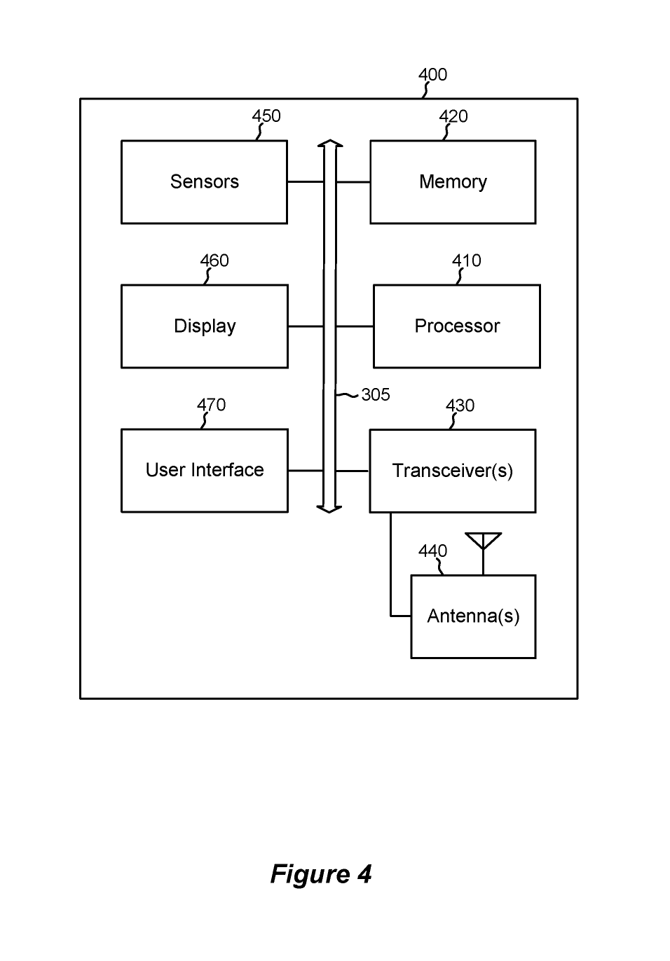

FIG. 4 shows a block diagram of an example wireless station (STA) 400 for use in wireless communication. For example, the STA 400 may be an example of aspects of the STA 115 described with reference to FIG. 1. The STA 400 can be configured to send and receive WLAN frames (also referred to herein as transmissions or communications) conforming to an IEEE 802.11 standard (such as the 802.11ac or 802.11ax amendments to the 802.11 family of standards), as well as to encode and decode such frames. The STA 400 includes a processor 410, a memory 420, at least one transceiver 430 and at least one antenna 440. In some implementations, the STA 400 additionally includes one or more of sensors 450, a display 460 and a user interface (UI) 470 (such as a touchscreen or keypad). Each of the components (or “modules”) described with reference to FIG. 4 can communicate with one another, directly or indirectly, over at least one bus 405.

The memory 420 can include RAM and ROM. The memory 420 also can store processor- or computer-executable SW code 425 containing instructions that, when executed, cause the processor 410 to perform various functions described herein for wireless communication, including reception of a downlink frame and generation and transmission of an uplink frame.

The processor 410 includes an intelligent hardware device such as, for example, a CPU, a microcontroller, an ASIC or a PLD such as an FPGA, among other possibilities. The processor 410 processes information received through the transceiver 430 as well as information to be sent to the transceiver 430 for transmission through the antenna 440. The processor 410 can be configured to perform various operations related to receiving a downlink frame and generating and transmitting an uplink frame.

The transceiver 430 can include a modem to modulate packets and provide the modulated packets to the antenna 440 for transmission, as well as to demodulate packets received from the antenna 440. The transceiver 430 can be implemented as at least one RF transmitter and at least one separate RF receiver. The transceiver 430 can communicate bi-directionally, via the antenna 440, with at least one AP 115 as, for example, shown in FIG. 1. Although only one transceiver 430 and one antenna 440 are shown in FIG. 4, the STA 400 can include two or more antennas. For example, in some STA implementations, the STA 400 can include multiple transmit antennas (each with a corresponding transmit chain) and multiple receive antennas (each with a corresponding receive chain).

As described above, various implementations relate generally to wireless communication systems. Some implementations more specifically relate to WLAN communication systems. In some implementations, the described techniques can be used to synchronize clocks of the AP and clocks of the STAs in a WLAN network.

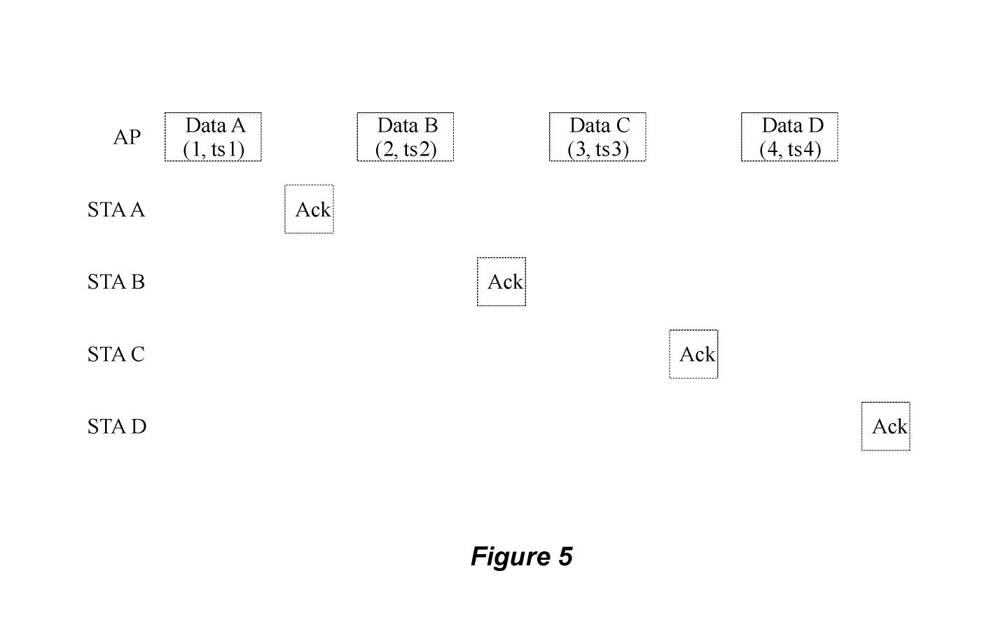

With regard to FIGS. 5-10, the AP may be provided as the AP 300 shown above. Additionally, the STAs shown in FIGS. 5-10 may each be provided as the STA 400 shown above. In some implementations, the AP can include an audio system and each of the STAs can include a wireless speaker.

FIG. 5 is an example operational diagram 500 related to one configuration for providing synchronization between devices in a WLAN. The WLAN network shown in FIG. 5 includes an AP and various STAs. More specifically, the WLAN network includes an STA A, an STAB, an STA C, an STA D. The devices of the WLAN network are listed in a vertical progression of the operational diagram 500 starting with the AP and then progressing through the various STA, starting with the STA A and ending with the STA D in alphabetical order. The horizontal progression in the operational diagram represents a temporal axis so that a vertical position of different messages are listed beside the particular device that transmits the message while their horizontal position represents a temporal association of the message relative to the other messages transmitted by the devices.

For example, the AP in FIG. 5 is configured to transmit a data packet, Data A, from the AP to the STA A. The data packet, Data A, has audio data directed towards the STA A embedded within data packet, Data A, and a time of departure (TOD) time stamp, ts1 embedded within the data packet, Data A. In one aspect, Data A may include a media timestamp associated with the audio data. The media timestamp may be captured by sampling a timestamp counter generated by a media clock of the AP. In one aspect, Data A may include other types of multimedia data such as video data. The data packet, Data A is associated with a token, 1, as shown in FIG. 5. The TOD time stamp, ts1, was captured by the HW capture circuit of the AP in response to detecting the initiation of transmission of data packet, Data A. This in turn shows the difficulty of the implementation shown in FIG. 5 in that the AP has to be able to capture and embed the TOD time stamp, ts1, in the data packet, Data A, once the transmission of the data packet, Data A, is detected. This is increasingly difficult, may require specialized hardware, and may not be practical in many applications.

The STA A is configured to receive the data packet, Data A, from the AP. For example, the STA A may be able to read a header in the data packet, Data A, and determine that the data packet, Data A, is directed to the STA A. The STAs STA B, STA C, and STA D may ignore or filter out the data packet, Data A based on determining that the data packet Data A is not directed to them. The STA A is configured to capture a time of arrival (TOA) timestamp in response to receiving the data packet, Data A, from the AP. Furthermore, the STA A is configured to extract the embedded TOD timestamp, ts1, from the data packet, Data A. The STA A may then compare the extracted TOD timestamp, ts1, with the captured TOA timestamp, which was captured in response to receiving the data packet, Data A. By comparing the extracted TOD timestamp, ts1, with the captured TOA timestamp, the STA A is configured to determine at least one timing difference between the WLAN clock of the AP and the WLAN clock of the STA A. The STA A may then thus adjust the WLAN clock of the STA A so that the WLAN clock of the STA A reduces the at least one timing difference between the WLAN clock of the AP and the WLAN clock of the STA A. In this manner, the WLAN clock of the AP and the WLAN clock of the STA A are synchronized by the STA A.

In response to receiving the data packet, Data A, the STA A may also capture a media timestamp from the media clock of the STA A. The STA A may compare the captured media timestamp with the captured TOA timestamp. By comparing the captured media timestamp with the captured TOA timestamp, the STA A is configured to determine at least one timing difference between the media clock of the STA A and the WLAN clock of the STA A. The STA A may then adjust the media clock of the STA A so that the media clock of the STA A reduces the at least one timing difference between the media clock of the STA A and the WLAN clock of the STA A. In this manner, the media clock of the STA A and the WLAN clock of the STA A are synchronized by the STA A.

With regard to the STA B, the AP in FIG. 5 is configured to transmit a data packet, Data B, from the AP to the STA B. The data packet, Data B, has audio data directed towards the STA B embedded within data packet, Data B, and a TOD time stamp, ts2 embedded within the data packet, Data B. In one aspect, Data B may include a media timestamp associated with the audio data. The media timestamp may be captured by sampling a timestamp counter generated by the media clock of the AP. The data packet, Data B, is associated with a token, 2, as shown in FIG. 5. The TOD time stamp, ts2, was captured by the HW capture circuit of the AP in response to detecting the initiation of transmission of data packet, Data B. This in turn shows the difficulty of the implementation shown in FIG. 5 in that the AP has to be able to capture and embed the TOD time stamp, ts2, in the data packet, Data B, once the transmission of the data packet, Data B, is detected. This is increasingly difficult, may require specialized hardware, and may not be practical in many applications.

The STA B is configured to receive the data packet, Data B, from the AP. For example, the STA B may be able to read a header in the data packet, Data B, and determine that the data packet, Data B, is directed to the STA B. The STAs STA A, STA C, and STA D may ignore or filter out the data packet, Data B, based on determining that the data packet Data B is not directed to them. The STA B is configured to capture a TOA timestamp in response to receiving the data packet, Data B, from the AP. Furthermore, the STA B is configured to extract the embedded TOD timestamp, ts2, from the data packet, Data B. The STA B may then compare the extracted TOD timestamp, ts2, with the captured TOA timestamp, which was captured in response to receiving the data packet, Data B. By comparing the extracted TOD timestamp, ts2, with the captured TOA timestamp, the STA B is configured to determine at least one timing difference between the WLAN clock of the AP and the WLAN clock of the STAB. The STA B may then thus adjust the WLAN clock of the STA B so that the WLAN clock of the STA B reduces the at least one timing difference between the WLAN clock of the AP and the WLAN clock of the STA B. In this manner, the WLAN clock of the AP and the WLAN clock of the STA B are synchronized by the STA B.

In response to receiving the data packet, Data B, the STA B may also capture a media timestamp from the media clock of the of the STA B. The STA B may compare the captured media timestamp with the captured TOA timestamp. By comparing the captured media timestamp with the captured TOA timestamp, the STA B is configured to determine at least one timing difference between the media clock of the STA B and the WLAN clock of the STA B. The STA B may then adjust the media clock of the STA B so that the media clock of the STA B reduces the at least one timing difference between the media clock of the STA B and the WLAN clock of the STA B. In this manner, the media clock of the STA B and the WLAN clock of the STA B are synchronized by the STA B.

With regard to the STA C, the AP in FIG. 5 is configured to transmit a data packet, Data C, from the AP to the STA C. The data packet, Data C, has audio data directed towards the STA C embedded within data packet, Data C, and a TOD time stamp, ts3 embedded within the data packet, Data C. In one aspect, Data C may include a media timestamp associated with the audio data. The media timestamp may be captured by sampling a timestamp counter generated by the media clock of the AP. The data packet, Data C, is associated with a token, 3, as shown in FIG. 5. The TOD time stamp, ts3, was captured by the HW capture circuit of the AP in response to detecting the initiation of transmission of data packet, Data C. This in turn shows the difficulty of the implementation shown in FIG. 5 in that the AP has to be able to capture and embed the TOD time stamp, ts3, in the data packet, Data C, once the transmission of the data packet, Data C, is detected. This is increasingly difficult, may require specialized hardware, and may not be practical in many applications.

The STA C is configured to receive the data packet, Data C, from the AP. For example, the STA C may be able to read a header in the data packet, Data C, and determine that the data packet, Data C, is directed to the STA C. The STA A, STA B, and STA D may ignore or filter out the data packet, Data C, based on determining that the data packet Data C is not directed to them. The STA C is configured to capture a TOA timestamp in response to receiving the data packet, Data C, from the AP. Furthermore, the STA C is configured to extract the embedded TOD timestamp, ts3, from the data packet, Data C. The STA C may then compare the extracted TOD timestamp, ts3, with the captured TOA timestamp, which was captured in response to receiving the data packet, Data C. By comparing the extracted TOD timestamp, ts3, with the captured TOA timestamp, the STA C is configured to determine at least one timing difference between the WLAN clock of the AP and the WLAN clock of the STA C. The STA C may then thus adjust the WLAN clock of the STA C so that the WLAN clock of the STA C reduces the at least one timing difference between the WLAN clock of the AP and the WLAN clock of the STA C. In this manner, the WLAN clock of the AP and the WLAN clock of the STA C are synchronized by the STA C.

In response to receiving the data packet, Data C, the STA C may also capture a media timestamp from the media clock of the of the STA C. The STA C may compare the captured media timestamp with the captured TOA timestamp. By comparing the captured media timestamp with the captured TOA timestamp, the STA C is configured to determine at least one timing difference between the media clock of the STA C and the WLAN clock of the STA C. The STA C may then adjust the media clock of the STA C so that the media clock of the STA C reduces the at least one timing difference between the media clock of the STA C and the WLAN clock of the STA C. In this manner, the media clock of the STA C and the WLAN clock of the STA C are synchronized by the STA C.

With regard to the STA D, the AP in FIG. 5 is configured to transmit a data packet, Data D, from the AP to the STA D. The data packet, Data D, has audio data directed towards the STA D embedded within data packet, Data D, and a TOD time stamp, ts4 embedded within the data packet, Data D. In one aspect, Data D may include a media timestamp associated with the audio data. The media timestamp may be captured by sampling a timestamp counter generated by the media clock of the AP. The data packet, Data D, is associated with a token, 4, as shown in FIG. 5. The TOD time stamp, ts4, was captured by the HW capture circuit of the AP in response to detecting the initiation of transmission of data packet, Data D. This in turn shows the difficulty of the implementation shown in FIG. 5 in that the AP has to be able to capture and embedded the TOD time stamp, ts4, in the data packet, Data D, once the transmission of the data packet, Data D, is detected. This is increasingly difficult, may require specialized hardware, and may not be practical in many applications.

The STA D is configured to receive the data packet, Data D, from the AP. For example, the STA D may be able to read a header in the data packet, Data D, and determine that the data packet, Data D, is directed to the STA D. The STA A, STA B, and STA C may ignore or filter out the data packet, Data D, based on determining that the data packet Data D is not directed to them. The STA D is configured to capture a TOA timestamp in response to receiving the data packet, Data D, from the AP. Furthermore, the STA D is configured to extract the embedded TOD timestamp, ts4, from the data packet, Data D. The STA D may then compare the extracted TOD timestamp, ts4, with the captured TOA timestamp, which was captured in response to receiving the data packet, Data D. By comparing the extracted TOD timestamp, ts4, with the captured TOA timestamp, the STA D is configured to determine at least one timing difference between the WLAN clock of the AP and the WLAN clock of the STA D. The STA D may then adjust the WLAN clock of the STA D so that the WLAN clock of the STA D reduces the at least one timing difference between the WLAN clock of the AP and the WLAN clock of the STA D. In this manner, the WLAN clock of the AP and the WLAN clock of the STA D are synchronized by the STA D.

In response to receiving the data packet, Data D, the STA D may also capture a media timestamp from the media clock of the STA D. The STA D may compare the captured media timestamp with the captured TOA timestamp. By comparing the captured media timestamp with the captured TOA timestamp, the STA D is configured to determine at least one timing difference between the media clock of the STA D and the WLAN clock of the STA D. The STA D may then adjust the media clock of the STA D so that the media clock of the STA D reduces the at least one timing difference between the media clock of the STA D and the WLAN clock of the STA D. In this manner, the media clock of the STA D and the WLAN clock of the STA D are synchronized by the STA D.

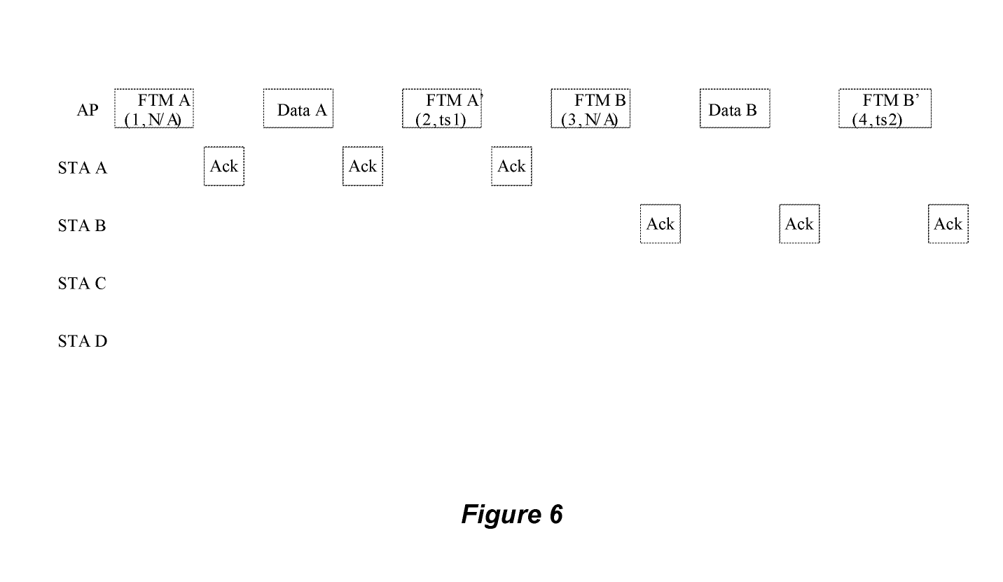

FIG. 6 is an example operational diagram 600 related to one configuration for providing synchronization between the devices in the WLAN network. The WLAN network shown in FIG. 6 includes the AP and the various STAs. More specifically, the WLAN network includes the STA A, the STAB, the STA C, the STA D. The devices of the WLAN network are listed in a vertical progression of the operational diagram 600 starting with the AP and then progressing through the various STA, starting with the STA A and ending with the STA D in alphabetical order. The horizontal progression in the operational diagram represents a temporal axis so that a vertical position of different messages are listed beside the particular device that transmits the message while their horizontal position represents a temporal association of the message relative to the other messages transmitted by the devices.

For example, the AP in FIG. 6 is configured to transmit a fine time measurement (FTM) packet, FTM A, from the AP to the STA A. Typically, FTM packets are used for location determination. However, in the particular implementation of FIG. 6, the FTM packet, FTM A, also is used for time synchronization as explained below. The AP is configured to capture a TOD timestamp, ts1, in response to transmitting the FTM packet, FTM A. However, note that the TOD timestamp, ts1, is not embedded in the FTM packet, FTM A. Instead of attempting to embed the TOD timestamp, ts1, in the FTM packet, FTM A, the AP holds the TOD timestamp, ts1, for later transmission. The FTM packet FTM A is associated with a token 1, as shown in FIG. 6. Additionally, in response to receiving the FTM packet, FTM A, the STA A may also capture a media timestamp from the media clock of the STA A.

The STA A is configured to receive the FTM packet, FTM A, at the STA A from the AP. The STA A may be able to read a header in the FTM packet, FTM A, and determine that the FTM packet, FTM A, is directed to the STA A. The STA B, STA C, and STA D may ignore or filter out the FTM packet, FTM A, based on determining that the FTM packet FTM A is not directed to them. The STA A is configured to capture a TOA timestamp in response to receiving the FTM packet, FTM A, from the AP. At this point, the STA A may however not be capable of providing synchronization with the WLAN clock of the AP because the STA A has not received the TOD timestamp, ts1. The AP may then be configured to transmit a data packet, Data A, to the STA A while the AP generates a FTM packet, FTM A′. The temporal length of data packet, Data A, provides sufficient latency for software (SW) executed by a processor to detect the TOD timestamp in a shadow register (See below) and then embed the TOD timestamp into a subsequent packet. In this aspect, the AP is configured to embed the TOD timestamp ts1 for the FTM packet, FTM A, into the FTM packet FTM A′. The AP is configured to transmit the FTM packet, FTM A′ from the AP to the STA A. The FTM packet, FTM A′ is associated with a token 2.

The STA A is configured to receive the FTM packet, FTM A′, from the AP. For example, the STA A may be able to read a header in the FTM packet, FTM A′, and determine that the FTM packet, FTM A′, is directed to the STA A. The STA B, STA C, and STA D may ignore or filter out the FTM packet, FTM A′, based on determining that the FTM packet FTM A′ is not directed to them. The STA A may then compare the extracted TOD timestamp, ts1 (which was for the FTM packet, FTM A), with the captured TOA timestamp, which was captured and held in response to receiving the FTM packet, FTM A. By comparing the extracted TOD timestamp, ts1, with the captured TOA timestamp, the STA A is configured to determine at least one timing difference between the WLAN clock of the AP and the WLAN clock of the STA A. The STA A may then adjust the WLAN clock of the STA A so that the WLAN clock of the STA A reduces the at least one timing difference between the WLAN clock of the AP and the WLAN clock of the STA A. In this manner, the WLAN clock of the AP and the WLAN clock of the STA A are synchronized by the STA A.

The timing differences between the WLAN clock of the AP and the WLAN clock of the STA A may be given in parts per million (PPM) and may include a clock offset, represented by B, and a frequency scaling factor (or frequency offset), represented by M. For example, through repeated triggering and analysis, the STA A is configured to determine the frequency scaling factor M between the WLAN clock in the AP and the WLAN clock of the STA A as well as the clock offset B. In one aspect, the TOA timestamp, WL(STA A) may be related to the TOD timestamp WL(AP) by the formula, WL(STA A)=M(WL(AP))+B. As such, the STA A may adjust the WLAN clock of the STA A to match the frequency and the clock offset of the WLAN clock of the AP based on the M and B calculated in accordance with the TOA timestamp and the TOD timestamp.

The STA A may also compare the captured media timestamp with the captured TOA timestamp for the FTM packet, FTM A. By comparing the captured media timestamp with the captured TOA timestamp, the STA A is configured to determine at least one timing difference between the media clock of the STA A and the WLAN clock of the STA A. The STA A may then adjust the media clock of the STA A so that the media clock of the STA A reduces the at least one timing difference between the media clock of the STA A and the WLAN clock of the STA A. In this manner, the media clock of the STA A and the WLAN clock of the STA A are synchronized by the STA A.

The timing differences between the media clock of the STA A and the WLAN clock of the STA A may be given in PPM and may include a clock offset, represented by B and a frequency scaling factor represented by M. For example, through repeated triggering and analysis, the STA A is configured to determine a frequency scaling factor M between the WLAN clock in the STA A and the media clock of the STA A as well as the clock offset B. In one aspect, the media timestamp, Audio(STA A) may be related to the TOA timestamp WL(STA A) by the formula, Audio(STA A)=M(WL(STA A))+B. As such, the STA A may adjust the media clock of the STA A to match the frequency and the clock offset of the WLAN clock of the STA A based on the M and B calculated in accordance with the TOA timestamp and the media timestamp.

With regard to STA B, the AP in FIG. 6 is configured to transmit a FTM packet, FTM B, from the AP to the STA B. As described above, FTM packets are typically used for location determination, but in the particular implementation of FIG. 6, the FTM packet, FTM B, also is used for time synchronization as explained below. The AP is configured to capture a TOD timestamp, ts2, in response to transmitting the FTM packet, FTM B. However, note that the TOD timestamp, ts2, is not embedded in the FTM packet, FTM B. Instead of attempting to embed the TOD timestamp, ts2, in the FTM packet, FTM B, the AP holds the TOD timestamp, ts2, for later transmission. The FTM packet FTM B is associated with a token 3, as shown in FIG. 6. Additionally, in response to receiving the FTM packet, FTM B, the STA B may also capture a media timestamp from the media clock of the STA B.

The STA B is configured to receive the FTM packet, FTM B, at the STA B from the AP. The STA B may be able to read a header in the FTM packet, FTM B, and determine that the FTM packet, FTM B, is directed to the STAB. The STA A, STA C, and STA D may thus ignore and filter out the FTM packet, FTM B. The STA B is configured to capture a TOA timestamp in response to receiving the FTM packet, FTM B, from the AP. At this point, the STA B may however not be capable of providing synchronization with the WLAN clock of the AP because the STA B has not received the TOD timestamp, ts2. The AP may then be configured to transmit a data packet, Data B, to the STA B while the AP generates a FTM packet, FTM B′. The temporal length of data packet, Data B, provides sufficient latency for SW executed by a processor to detect the TOD timestamp in a shadow register (See below) and then embed the TOD timestamp into a subsequent packet. In this aspect, the AP is configured to embed the TOD timestamp for the FTM packet, FTM B, into the FTM packet FTM B′. The AP is configured to transmit the FTM packet, FTM B′ from the AP to the STA B. The FTM packet, FTM B′ is associated with a token 4.

The STA B is configured to receive the FTM packet, FTM B′, from the AP. For example, the STA B may be able to read a header in the FTM packet, FTM B′, and determine that the FTM packet, FTM B′, is directed to the STA B. The STA A, STA C, and STA D may ignore or filter out the FTM packet, FTM B′, based on determining that the FTM packet FTM B′ is not directed to them. The STA B may then compare the extracted TOD timestamp, ts2 (which was for the FTM packet, FTM B), with the captured TOA timestamp, which was captured and held in response to receiving the FTM packet, FTM B. By comparing the extracted TOD timestamp, ts2, with the captured TOA timestamp, the STA B is configured to determine at least one timing difference between the WLAN clock of the AP and the WLAN clock of the STA B. The STA B may then adjust the WLAN clock of the STA B so that the WLAN clock of the STA B reduces the at least one timing difference between the WLAN clock of the AP and the WLAN clock of the STA B. In this manner, the WLAN clock of the AP and the WLAN clock of the STA B are synchronized by the STA B.

The timing differences between the WLAN clock of the AP and the WLAN clock of the STA B may be given in PPM and may include a clock offset, represented by B and a frequency scaling factor represented by M. For example, through repeated triggering and analysis, the STA B is configured to determine the frequency scaling factor M between the WLAN clock in the AP and the WLAN clock of the STA B as well as the clock offset (B). In one aspect, the TOA timestamp, WL(STA B) may be related to the TOD timestamp WL(AP) by the formula, WL(STA B)=M(WL(AP))+B. As such, the STA B may adjust the WLAN clock of the STA B to match the frequency and the clock offset of the WLAN clock of the AP based on the M and B calculated in accordance with the TOA timestamp and the TOD timestamp.

The STA B may also compare the captured media timestamp with the captured TOA timestamp for the FTM packet, FTM B. By comparing the captured media timestamp with the captured TOA timestamp, the STA B is configured to determine at least one timing difference between the media clock of the STA B and the WLAN clock of the STA B. The STA B may then adjust the media clock of the STA B so that the media clock of the STA B reduces the at least one timing difference between the media clock of the STA B and the WLAN clock of the STA B. In this manner, the media clock of the STA B and the WLAN clock of the STA B are synchronized by the STA B.

The timing differences between the media clock of the STA B and the WLAN clock of the STA B may be given in PPM and may include a clock offset, represented by B and a frequency scaling factor represented by M. For example, through repeated triggering and analysis, the STA B is configured to determine the frequency scaling factor M between the WLAN clock in the STA B and the media clock of the STA B as well as the clock offset B. In one aspect, the media timestamp, Audio(STA B) may be related to the TOA timestamp WL(STA B) by the formula, Audio(STA B)=M(WL(STA B))+B. As such, the STA B may adjust the media clock of the STA B to match the frequency and the clock offset of the WLAN clock of the STA B based on the M and B calculated in accordance with the TOA timestamp and the media timestamp.

Analogous FTM packets and data packets may be transmitted by the AP and received by the STA C and the STA D in order to synchronize the STA C and the STA D.

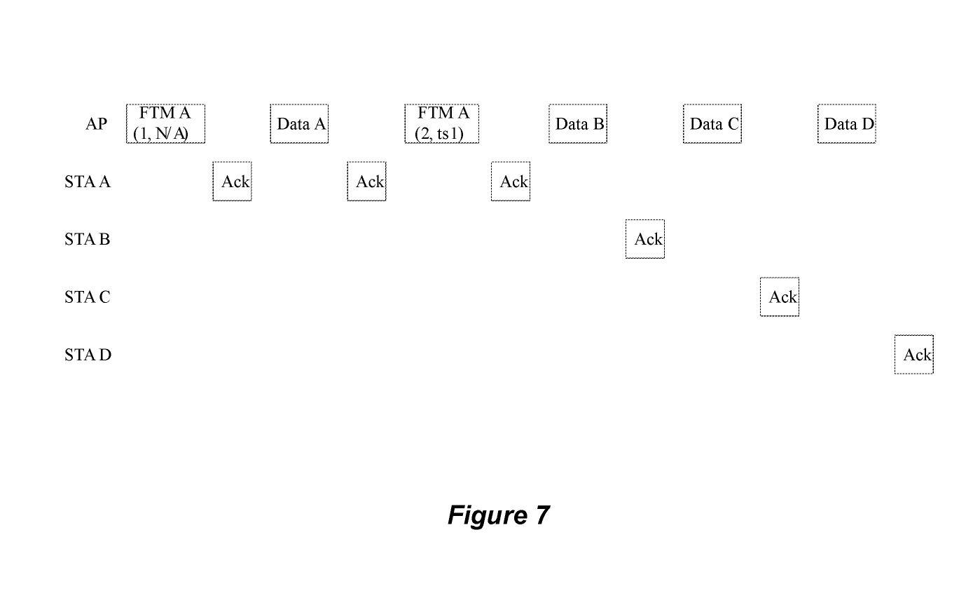

FIG. 7 is an example operational diagram 700 related to one configuration for providing synchronization between the devices in the WLAN network. The WLAN network shown in FIG. 7 includes the AP and the various STAs. More specifically, the WLAN network includes the STA A, the STAB, the STA C, the STA D. The devices of the WLAN network are listed in a vertical progression of the operational diagram 700 starting with the AP and then progressing through the various STA, starting with the STA A and ending with the STA D in alphabetical order. The horizontal progression in the operational diagram represents a temporal axis so that a vertical position of different messages are listed beside the particular device that transmits the message while their horizontal position represents a temporal association of the message relative to the other messages transmitted by the devices.

In the implementation shown in FIG. 7, the STA A, STA B, STA C and STA D are all configured in a promiscuous mode. When any one of the STA A, STA B, STA C or STA D are placed in the promiscuous mode, the STA A, STA B, STA C or STA D are configured to receive and process any of the packets directed to any of the other STAs. For example, the AP in FIG. 7 is configured to transmit a FTM packet, FTM A, from the AP to the STA A. The AP is configured to capture a TOD timestamp, ts1, in response to transmitting the FTM packet, FTM A. However, note that the TOD timestamp, ts1, is not embedded in the FTM packet, FTM A. Instead of attempting to embed the TOD timestamp, ts1, in the FTM packet, FTM A, the AP holds the TOD timestamp, ts1, for later transmission. The FTM packet FTM A is associated with a token 1, as shown in FIG. 7.

The STA A is configured to receive the FTM packet, FTM A, at the STA A from the AP. Since the STA A is provided in the promiscuous mode, the destination address in the header of the FTM packet, FTM A is irrelevant. The STA A is configured to capture a TOA timestamp in response to receiving the FTM packet, FTM A, from the AP. Additionally, in response to receiving the FTM packet, FTM A, the STA A may also capture a media timestamp from the media clock of the STA A.

At this point, the STA A may however not be capable of providing synchronization with the WLAN clock of the AP because the STA A has not received the TOD timestamp, ts1. The AP may then be configured to transmit a data packet, Data A, to the STA A while the AP generates a FTM packet, FTM A′. The temporal length of data packet, Data A, provides sufficient latency for SW executed by a processor to detect the TOD timestamp in a shadow register (See below) and then embed the TOD timestamp into a subsequent packet. In this aspect, the AP is configured to embed the TOD timestamp for the FTM packet, FTM A, into the FTM packet FTM A′. The AP is configured to transmit the FTM packet, FTM A′ from the AP to the STA A. The FTM packet, FTM A′ is associated with a token 2.

The STA A is configured to receive the FTM packet, FTM A′, from the AP.

Because the STA A is in the promiscuous mode, the destination address in the header of the FTM packet, FTM A′ is irrelevant. The STA A may then compare the extracted TOD timestamp, ts1 (which was for the FTM packet, FTM A), with the captured TOA timestamp, which was captured and held in response to receiving the FTM packet, FTM A. By comparing the extracted TOD timestamp, ts1, with the captured TOA timestamp, the STA A is configured to determine at least one timing difference between the WLAN clock of the AP and the WLAN clock of the STA A. The STA A may then adjust the WLAN clock of the STA A so that the WLAN clock of the STA A reduces the at least one timing difference between the WLAN clock of the AP and the WLAN clock of the STA A. In this manner, the WLAN clock of the AP and the WLAN clock of the STA A are synchronized by the STA A.

The STA A may also compare the captured media timestamp with the captured TOA timestamp for the FTM packet, FTM A. By comparing the captured media timestamp with the captured TOA timestamp, the STA A is configured to determine at least one timing difference between the media clock of the STA A and the WLAN clock of the STA A. The STA A may then adjust the media clock of the STA A so that the media clock of the STA A reduces the at least one timing difference between the media clock of the STA A and the WLAN clock of the STA A. In this manner, the media clock of the STA A and the WLAN clock of the STA A are synchronized by the STA A.

The timing differences between the WLAN clock of the AP and the WLAN clock of the STA A may be given in PPM and may include a clock offset, represented by B and a frequency scaling factor represented by M. For example, through repeated triggering and analysis, the STA A is configured to determine the frequency scaling factor M between the WLAN clock in the AP and the WLAN clock of the STA A as well as the clock offset B. In one aspect, the TOA timestamp, WL(STA A) may be related to the TOD timestamp WL(AP) by the formula, WL(STA A)=M(WL(AP))+B. As such, the STA A may adjust the WLAN clock of the STA A to match the frequency and the clock offset of the WLAN clock of the AP based on the M and B calculated in accordance with the TOA timestamp and the TOD timestamp.

The timing differences between the media clock of the STA A and the WLAN clock of the STA A may be given in PPM and may include a clock offset, represented by B and a frequency scaling factor represented by M. For example, through repeated triggering and analysis, the STA A is configured to determine the frequency scaling factor M between the WLAN clock in the STA A and the media clock of the STA A and the clock offset B. In one aspect, the media timestamp, Audio(STA A) may be related to the TOA timestamp WL(STA A) by the formula, Audio(STA A)=M(WL(STA A))+B. As such, the STA A may adjust the media clock of the STA A to match the frequency and the clock offset of the WLAN clock of the STA A based on the M and B calculated in accordance with the TOA timestamp and the media timestamp.

With regard to the STA B, the STA B is also configured to receive the FTM packet, FTM A, at the STA B from the AP. Since the STA B is provided in the promiscuous mode, the destination address in the header of the FTM packet, FTM A is irrelevant. The STA B is configured to capture a TOA timestamp in response to receiving the FTM packet, FTM A, from the AP. Additionally, in response to receiving the FTM packet, FTM A, the STA B may also capture a media timestamp from the media clock of the STA B.

At this point, the STA B may however not be capable of providing synchronization with the WLAN clock of the AP because the STA B has not received the TOD timestamp, ts1. The AP may then be configured to transmit a data packet, Data B, to the STA B while the AP prepares the FTM packet, FTM A′. The temporal length of data packet, Data A, provides sufficient latency for SW executed by a processor to detect the TOD timestamp in a shadow register (See below) and then embed the TOD timestamp into a subsequent packet. In this aspect, the AP is configured to embed the TOD timestamp for the FTM packet, FTM A, into the FTM packet FTM A′. The AP is configured to transmit the FTM packet, FTM A′ from the AP to the STA B.

The STA B is configured to receive the FTM packet, FTM A′, from the AP. Because the STA B is in the promiscuous mode, the destination address in the header of the FTM packet, FTM A′ is irrelevant. The STA B may then compare the extracted TOD timestamp, ts1 (which was for the FTM packet, FTM A), with the captured TOA timestamp, which was captured and held in response to receiving the FTM packet, FTM A. By comparing the extracted TOD timestamp, ts1, with the captured TOA timestamp, the STA B is configured to determine at least one timing difference between the WLAN clock of the AP and the WLAN clock of the STA B. The STA B may then adjust the WLAN clock of the STA B so that the WLAN clock of the STA B reduces the at least one timing difference between the WLAN clock of the AP and the WLAN clock of the STA B. In this manner, the WLAN clock of the AP and the WLAN clock of the STA B are synchronized by the STA B.

The STA B may also compare the captured media timestamp with the captured TOA timestamp for the FTM packet, FTM A. By comparing the captured media timestamp with the captured TOA timestamp, the STA B is configured to determine at least one timing difference between the media clock of the STA B and the WLAN clock of the STA B. The STA B may then thus adjust the media clock of the STA B so that the media clock of the STA B reduces the at least one timing difference between the media clock of the STA B and the WLAN clock of the STA B. In this manner, the media clock of the STA B and the WLAN clock of the STA B are synchronized by the STA B.

The timing differences between the WLAN clock of the AP and the WLAN clock of the STA B may be given in PPM and may include a clock offset, represented by B and a frequency scaling factor represented by M. For example, through repeated triggering and analysis, the STA B is configured to determine the frequency scaling factor M between the WLAN clock in the AP and the WLAN clock of the STA B as well as the clock offset B. In one aspect, the TOA timestamp, WL(STA B) may be related to the TOD timestamp WL(AP) by the formula, WL(STAB)=M(WL(AP))+B. As such, the STA B may adjust the WLAN clock of the STA B to match the frequency and the clock offset of the WLAN clock of the AP based on the M and B calculated in accordance with the TOA timestamp and the TOD timestamp.

The timing differences between the media clock of the STA B and the WLAN clock of the STA B may be given in PPM and may include a clock offset, represented by B and a frequency scaling factor represented by M. For example, through repeated triggering and analysis, the STA B is configured to determine the frequency scaling factor M between the WLAN clock in the STA B and the media clock of the STA B as well as the clock offset B. In one aspect, the media timestamp, Audio(STA B) may be related to the TOA timestamp WL(STA B) by the formula, Audio(STA B)=M(WL(STA B))+B. As such, the STA B may adjust the media clock of the STA B to match the frequency and the clock offset of the WLAN clock of the STA B based on the M and B calculated in accordance with the TOA timestamp and the media timestamp.

With regard to the STA C, the STA C is also configured to receive the FTM packet, FTM A, at the STA C from the AP. Since the STA C is provided in the promiscuous mode, the destination address in the header of the FTM packet, FTM A is irrelevant. The STA C is configured to capture a TOA timestamp in response to receiving the FTM packet, FTM A, from the AP. Additionally, in response to receiving the FTM packet, FTM A, the STA C may also capture a media timestamp from the media clock of the STA C.

At this point, the STA C may however not be capable of providing synchronization with the WLAN clock of the AP because the STA C has not received the TOD timestamp, ts1. The AP may then be configured to transmit a data packet, Data C, to the STA C while the AP prepares the FTM packet, FTM A′. The temporal length of data packet, Data C, provides sufficient latency for SW executed by a processor to detect the TOD timestamp in a shadow register (See below) and then embed the TOD timestamp into a subsequent packet. In this aspect, the AP is configured to embed the TOD timestamp for the FTM packet, FTM A, into the FTM packet FTM A′. The AP is configured to transmit the FTM packet, FTM A′ from the AP to the STA C.

The STA C is configured to receive the FTM packet, FTM A′, from the AP. Because the STA C is in the promiscuous mode, the destination address in the header of the FTM packet, FTM A′ is irrelevant. The STA C may then compare the extracted TOD timestamp, ts1 (which was for the FTM packet, FTM A), with the captured TOA timestamp, which was captured and held in response to receiving the FTM packet, FTM A. By comparing the extracted TOD timestamp, ts1, with the captured TOA timestamp, the STA C is configured to determine at least one timing difference between the WLAN clock of the AP and the WLAN clock of the STA C. The STA C may then adjust the WLAN clock of the STA C so that the WLAN clock of the STA C reduces the at least one timing difference between the WLAN clock of the AP and the WLAN clock of the STA C. In this manner, the WLAN clock of the AP and the WLAN clock of the STA C are synchronized by the STA C.

The STA C may also compare the captured media timestamp with the captured TOA timestamp for the FTM packet, FTM A. By comparing the captured media timestamp with the captured TOA timestamp, the STA C is configured to determine at least one timing difference between the media clock of the STA C and the WLAN clock of the STA C. The STA C may then adjust the media clock of the STA C so that the media clock of the STA C reduces the at least one timing difference between the media clock of the STA C and the WLAN clock of the STA C. In this manner, the media clock of the STA C and the WLAN clock of the STA C are synchronized by the STA C.

The timing differences between the WLAN clock of the AP and the WLAN clock of the STA C may be given in PPM and may include a clock offset, represented by B and a frequency scaling factor represented by M. For example, through repeated triggering and analysis, the STA C is configured to determine the frequency scaling factor M between the WLAN clock in the AP and the WLAN clock of the STA C as well as the clock offset B. In one aspect, the TOA timestamp, WL(STA C) may be related to the TOD timestamp WL(AP) by the formula, WL(STA C)=M(WL(AP))+B. As such, the STA C may adjust the WLAN clock of the STA C to match the frequency and the clock offset of the WLAN clock of the AP based on the M and B calculated in accordance with the TOA timestamp and the TOD timestamp.

The timing differences between the media clock of the STA C and the WLAN clock of the STA C may be given in PPM and may include a clock offset, represented by B and a frequency scaling factor represented by M. For example, through repeated triggering and analysis, the STA C is configured to determine the frequency scaling factor M between the WLAN clock in the STA C and the media clock of the STA C as well as the clock offset B. In one aspect, the media timestamp, Audio(STA C) may be related to the TOA timestamp WL(STA C) by the formula, Audio(STA C)=M(WL(STA C))+B. As such, the STA C may adjust the media clock of the STA C to match the frequency and the clock offset of the WLAN clock of the STA C based on the M and B calculated in accordance with the TOA timestamp and the media timestamp.

With regard to the STA D, the STA D is also configured to receive the FTM packet, FTM A, at the STA D from the AP. Because the STA D is provided in the promiscuous mode, the destination address in the header of the FTM packet, FTM A is irrelevant. Additionally, in response to receiving the FTM packet, FTM A, the STA D may also capture a media timestamp from the media clock of the STA D.

The STA D is configured to capture a TOA timestamp in response to receiving the FTM packet, FTM A, from the AP. At this point, the STA D may however not be capable of providing synchronization with the WLAN clock of the AP because the STA D has not received the TOD timestamp, ts1. The AP may then be configured to transmit a data packet, Data D, to the STA D while the AP prepares the FTM packet, FTM A′. The temporal length of data packet, Data D, provides sufficient latency for SW executed by a processor to detect the TOD timestamp in a shadow register (See below) and then embed the TOD timestamp into a subsequent packet. In this aspect, the AP is configured to embed the TOD timestamp for the FTM packet, FTM A, into the FTM packet FTM A′. The AP is configured to transmit the FTM packet, FTM A′ from the AP to the STA D.

The STA D is configured to receive the FTM packet, FTM A′, from the AP. Because the STA D is in the promiscuous mode, the destination address in the header of the FTM packet, FTM A′ is irrelevant. The STA D may then compare the extracted TOD timestamp, ts1 (which was for the FTM packet, FTM A), with the captured TOA timestamp, which was captured and held in response to receiving the FTM packet, FTM A. By comparing the extracted TOD timestamp, ts1, with the captured TOA timestamp, the STA D is configured to determine at least one timing difference between the WLAN clock of the AP and the WLAN clock of the STA D. The STA D may then adjust the WLAN clock of the STA D so that the WLAN clock of the STA D reduces the at least one timing difference between the WLAN clock of the AP and the WLAN clock of the STA D. In this manner, the WLAN clock of the AP and the WLAN clock of the STA D are synchronized by the STA D.

The STA D may also compare the captured media timestamp with the captured TOA timestamp for the FTM packet, FTM A. By comparing the captured media timestamp with the captured TOA timestamp, the STA D is configured to determine at least one timing difference between the media clock of the STA D and the WLAN clock of the STA D. The STA D may then adjust the media clock of the STA D so that the media clock of the STA D reduces the at least one timing difference between the media clock of the STA D and the WLAN clock of the STA D. In this manner, the media clock of the STA D and the WLAN clock of the STA D are synchronized by the STA D.

The timing differences between the WLAN clock of the AP and the WLAN clock of the STA D may be given in PPM and may include a clock offset, represented by B and a frequency scaling factor represented by M. For example, through repeated triggering and analysis, the STA D is configured to determine the frequency scaling factor M between the WLAN clock in the AP and the WLAN clock of the STA D as well as the clock offset B. In one aspect, the TOA timestamp, WL(STA D) may be related to the TOD timestamp WL(AP) by the formula, WL(STA D)=M(WL(AP))+B. As such, the STA D may adjust the WLAN clock of the STA D to match the frequency and the clock offset of the WLAN clock of the AP based on the M and B calculated in accordance with the TOA timestamp and the TOD timestamp.

The timing differences between the media clock of the STA D and the WLAN clock of the STA D may be given in PPM and may include a clock offset, represented by B and a frequency scaling factor represented by M. For example, through repeated triggering and analysis, the STA D is configured to determine the frequency scaling factor M between the WLAN clock in the STA D and the media clock of the STA D as well as the clock offset B. In one aspect, the media timestamp, Audio(STA D) may be related to the TOA timestamp WL(STA D) by the formula, Audio(STA D)=M(WL(STA D))+B. As such, the STA D may adjust the media clock of the STA D to match the frequency and the clock offset of the WLAN clock of the STA D based on the M and B calculated in accordance with the TOA timestamp and the media timestamp.

Note that the number of data packets required for synchronization is significantly reduced as a total of two FTM packets are provided to provide synchronization for all of the STAs when the STAs are operating in the promiscuous mode. Furthermore, note that the same result can be achieved if the AP broadcasts or multicasts (as opposed to unicasts) an FTM packet, like the FTM packet, FTM A and another FTM packet, like the FTM packet, FTM A′. The only difference would be instead of the FTM packet A being directed to the STA A and the FTM packet, FTM A′ being directed to the STA A, the two FTM packets would be broadcast FTM packets directed to all the STAs in the WLAN network. In this manner, the STA A, the STA B, the STA C, and the STA D would not have to be provided in the promiscuous mode. Rather, the STA A, the STA B, the STA C, and the STA D would recognize that the two FTM packets are broadcast FTM packets for all of the STAs.

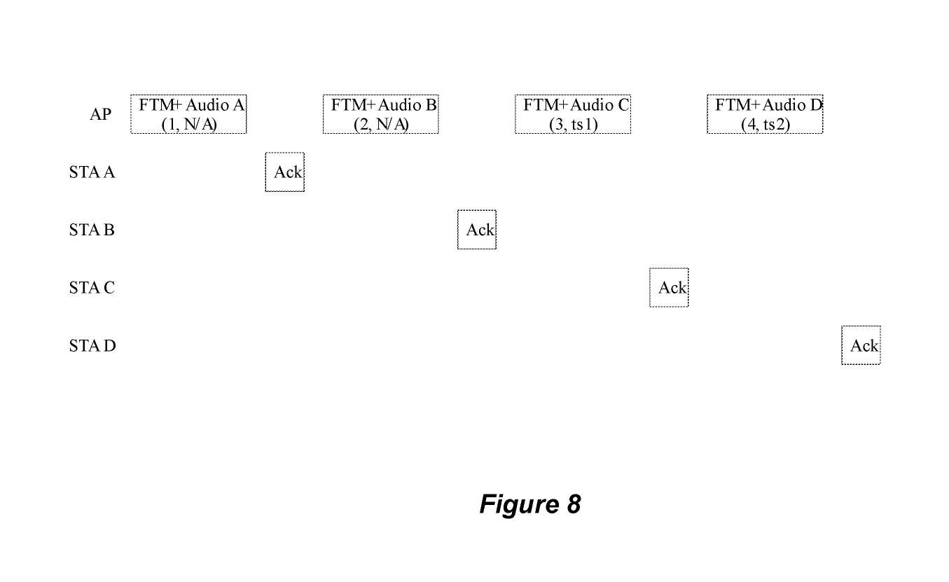

FIG. 8 is an example operational diagram 800 related to one configuration for providing synchronization between the devices in the WLAN network. The WLAN network shown in FIG. 8 includes the AP and the various STAs. More specifically, the WLAN network includes the STA A, the STAB, the STA C, the STA D. The devices of the WLAN network are listed in a vertical progression of the operational diagram 800 starting with the AP and then progressing through the various STA, starting with the STA A and ending with the STA D in alphabetical order. The horizontal progression in the operational diagram represents a temporal axis so that a vertical position of different messages are listed beside the particular device that transmits the message while their horizontal position represents a temporal association of the message relative to the other messages transmitted by the devices.

In the implementation shown in FIG. 8, the STA A, STA B, STA C and STA D are all placed in the promiscuous mode. When any one of the STA A, STAB, STA C or STA D are placed in the promiscuous mode, the STA A, STA B, STA C or STA D are configured to receive and process any of the packets directed to any of the other STAs. In this implementation, there are two synchronization events.

More specifically, the AP in FIG. 8 is configured to transmit a FTM packet, FTM+Audio A, from the AP to the STA A. That is, unlike in the implementations of FIGS. 5-7, the timestamps are combined with the data packets (with Audio A, Audio B, Audio C and Audio D being targeted to STA A, STA B, STA C and STA D, respectively). The AP is configured to capture a TOD timestamp, ts1, in response to transmitting the FTM packet, FTM+Audio A. However, note that the TOD timestamp, ts1, is not embedded in the FTM packet, FTM+Audio A. Instead of attempting to embed the TOD timestamp, ts1, in the FTM packet, FTM+Audio A, the AP holds the TOD timestamp, ts1, for later transmission. The FTM packet FTM+Audio A is associated with a token 1, as shown in FIG. 8. In this implementation, the AP may be configured to embed audio data into the FTM packet, FTM+Audio A directed to the STA A. The temporal length of audio data provides sufficient latency for SW executed by a processor to detect the TOD timestamp, ts1, in a shadow register (See below) and then embed the TOD timestamp into a subsequent packet. At this point, the STA A may however not be capable of providing synchronization with the WLAN clock of the AP because the STA A has not received the TOD timestamp, ts1. In one aspect, Audio A may include a media timestamp associated with the audio data of Audio A. The media timestamp may be captured by sampling a timestamp counter generated by the media clock of the AP. In one aspect,

Furthermore, the AP in FIG. 8 is configured to transmit a FTM packet, FTM+Audio B, from the AP to the STA B. The AP is configured to capture a TOD timestamp, ts2, in response to transmitting the FTM packet, FTM+Audio B. However, note that the TOD timestamp, ts2, is not embedded in the FTM packet, FTM+Audio B. Instead of attempting to embed the TOD timestamp, ts2, in the FTM packet, FTM+Audio B, the AP holds the TOD timestamp, ts2, for later transmission. The FTM packet FTM+Audio B is associated with a token 2, as shown in FIG. 8. In this implementation, the AP may be configured to embed audio data into the FTM packet, FTM+Audio B directed to the STA B. The temporal length of audio data provides sufficient latency for SW executed by a processor to detect the TOD timestamp, ts2, in a shadow register (See below) and then embed the TOD timestamp into a subsequent packet. In one aspect, Audio B may include a media timestamp associated with the audio data of Audio B. The media timestamp may be captured by sampling a timestamp counter generated by the media clock of the AP. In one aspect, the AP may be configured to embed other types of multimedia data, such as video data into the FTM packet.

The STA A is configured to receive the FTM packet, FTM+Audio A, at the STA A from the AP. Because the STA A is provided in the promiscuous mode, the destination address in the header of the FTM packet, FTM+Audio A is irrelevant. The STA A is configured to capture a TOA timestamp in response to receiving the FTM packet, FTM+Audio A, from the AP. Additionally, in response to receiving the FTM packet, FTM+Audio A, the STA A may also capture a media timestamp from the media clock of the STA A.

The STA B is configured to receive the FTM packet, FTM+Audio A, at the STA B from the AP. Because the STA B is provided in the promiscuous mode, the destination address in the header of the FTM packet, FTM+Audio A is irrelevant. The STA B is configured to capture a TOA timestamp in response to receiving the FTM packet, FTM+Audio A, from the AP. Additionally, in response to receiving the FTM packet, FTM+Audio A, the STA B may also capture a media timestamp from the media clock of the STA B.

The STA C is configured to receive the FTM packet, FTM+Audio A, at the STA C from the AP. Because the STA C is provided in the promiscuous mode, the destination address in the header of the FTM packet, FTM+Audio A is irrelevant. The STA C is configured to capture a TOA timestamp in response to receiving the FTM packet, FTM+Audio A, from the AP. Additionally, in response to receiving the FTM packet, FTM+Audio A, the STA C may also capture a media timestamp from the media clock of the STA C.

The STA D is configured to receive the FTM packet, FTM+Audio A, at the STA D from the AP. Because the STA D is provided in the promiscuous mode, the destination address in the header of the FTM packet, FTM+Audio A is irrelevant. The STA D is configured to capture a TOA timestamp in response to receiving the FTM packet, FTM+Audio A, from the AP. Additionally, in response to receiving the FTM packet, FTM+Audio A, the STA D may also capture a media timestamp from the media clock of the STA D.

Furthermore, the AP is configured to embed the TOD timestamp for the FTM packet, FTM+Audio A, into the FTM packet FTM+Audio C. In addition, the AP is configured to embed audio data for the STA C into the FTM packet FTM+Audio C. The AP is configured to transmit the FTM packet, FTM+Audio C from the AP to the STA C, but the FTM packet FTM+Audio C may be received by STA A, STA B, and STA D if they are configured in the promiscuous mode. The FTM packet, FTM+Audio C is associated with a token 3. In one aspect, Audio C may include a media timestamp associated with the audio data of Audio C. The media timestamp may be captured by sampling a timestamp counter generated by the media clock of the AP.

The STA A is configured to receive the FTM packet, FTM+Audio C, from the AP. Since the STA A is in the promiscuous mode, the destination address in the header of the FTM packet, FTM+Audio C is irrelevant. The STA A may then compare the extracted TOD timestamp, ts1 (which was for the FTM packet, FTM+Audio A), with the captured TOA timestamp, which was captured and held in response to receiving the FTM packet, FTM+Audio A. By comparing the extracted TOD timestamp, ts1, with the captured TOA timestamp, the STA A is configured to determine at least one timing difference between the WLAN clock of the AP and the WLAN clock of the STA A. The STA A may then adjust the WLAN clock of the STA A so that the WLAN clock of the STA A reduces the at least one timing difference between the WLAN clock of the AP and the WLAN clock of the STA A. In this manner, the WLAN clock of the AP and the WLAN clock of the STA A are synchronized by the STA A.

The STA A may also compare the captured media timestamp with the captured TOA timestamp for the FTM packet, FTM+Audio A. By comparing the captured media timestamp with the captured TOA timestamp, the STA A is configured to determine at least one timing difference between the media clock of the STA A and the WLAN clock of the STA A. The STA A may then adjust the media clock of the STA A so that the media clock of the STA A reduces the at least one timing difference between the media clock of the STA A and the WLAN clock of the STA A. In this manner, the media clock of the STA A and the WLAN clock of the STA A are synchronized by the STA A.

The timing differences between the WLAN clock of the AP and the WLAN clock of the STA A may be given in PPM and may include a clock offset, represented by B and a frequency scaling factor represented by M. For example, through repeated triggering and analysis, the STA A is configured to determine the frequency scaling factor M between the WLAN clock in the AP and the WLAN clock of the STA A as well as the clock offset B. In one aspect, the TOA timestamp, WL(STA A) may be related to the TOD timestamp WL(AP) by the formula, WL(STA A)=M(WL(AP))+B. As such, the STA A may adjust the WLAN clock of the STA A to match the frequency and the clock offset of the WLAN clock of the AP based on the M and B calculated in accordance with the TOA timestamp and the TOD timestamp.

The timing differences between the media clock of the STA A and the WLAN clock of the STA A may be given in PPM and may include a clock offset, represented by B and a frequency scaling factor represented by M. For example, through repeated triggering and analysis, the STA A is configured to determine the frequency scaling factor M between the WLAN clock in the STA A and the media clock of the STA A as well as the clock offset B. In one aspect, the media timestamp, Audio(STA A) may be related to the TOA timestamp WL(STA A) by the formula, Audio(STA A)=M(WL(STA A))+B. As such, the STA A may adjust the media clock of the STA A to match the frequency and the clock offset of the WLAN clock of the STA A based on the M and B calculated in accordance with the TOA timestamp and the media timestamp.

The STA B is configured to receive the FTM packet, FTM+Audio C, from the AP. Because the STA B is in the promiscuous mode, the destination address in the header of the FTM packet, FTM+Audio C is irrelevant. The STA B may then compare the extracted TOD timestamp, ts1 (which was for the FTM packet, FTM+Audio A), with the captured TOA timestamp, which was captured and held in response to receiving the FTM packet, FTM+Audio A. By comparing the extracted TOD timestamp, ts1, with the captured TOA timestamp, the STA B is configured to determine at least one timing difference between the WLAN clock of the AP and the WLAN clock of the STAB. The STA B may then adjust the WLAN clock of the STA B so that the WLAN clock of the STA B reduces the at least one timing difference between the WLAN clock of the AP and the WLAN clock of the STA B. In this manner, the WLAN clock of the AP and the WLAN clock of the STA B are synchronized by the STA B.

The STA B may also compare the captured media timestamp with the captured TOA timestamp for the FTM packet, FTM+Audio A. By comparing the captured media timestamp with the captured TOA timestamp, the STA B is configured to determine at least one timing difference between the media clock of the STA B and the WLAN clock of the STA B. The STA B may then adjust the media clock of the STA B so that the media clock of the STA B reduces the at least one timing difference between the media clock of the STA B and the WLAN clock of the STAB. In this manner, the media clock of the STA B and the WLAN clock of the STA B are synchronized by the STA B.

The timing differences between the WLAN clock of the AP and the WLAN clock of the STA B may be given in PPM and may include a clock offset, represented by B and a frequency scaling factor represented by M. For example, through repeated triggering and analysis, the STA B is configured to determine the frequency scaling factor M between the WLAN clock in the AP and the WLAN clock of the STA B as well as the clock offset B. In one aspect, the TOA timestamp, WL(STA B) may be related to the TOD timestamp WL(AP) by the formula, WL(STA B)=M(WL(AP))+B. As such, the STA B may adjust the WLAN clock of the STA B to match the frequency and the clock offset of the WLAN clock of the AP based on the M and B calculated in accordance with the TOA timestamp and the TOD timestamp.

The timing differences between the media clock of the STA B and the WLAN clock of the STA B may be given in PPM and may include a clock offset, represented by B and a frequency scaling factor represented by M. For example, through repeated triggering and analysis, the STA B is configured to determine the frequency scaling factor M between the WLAN clock in the STA B and the media clock of the STA B and the clock offset B. In one aspect, the media timestamp, Audio(STA B) may be related to the TOA timestamp WL(STA B) by the formula, Audio(STA B)=M(WL(STA B))+B. As such, the STA B may adjust the media clock of the STA B to match the frequency and the clock offset of the WLAN clock of the STA B based on the M and B calculated in accordance with the TOA timestamp and the media timestamp.

The STA C is configured to receive the FTM packet, FTM+Audio C, from the AP. Since the STA C is in the promiscuous mode, the destination address in the header of the FTM packet, FTM+Audio C is irrelevant. The STA C may then compare the extracted TOD timestamp, ts1 (which was for the FTM packet, FTM+Audio A), with the captured TOA timestamp, which was captured and held in response to receiving the FTM packet, FTM+Audio A. By comparing the extracted TOD timestamp, ts1, with the captured TOA timestamp, the STA C is configured to determine at least one timing difference between the WLAN clock of the AP and the WLAN clock of the STA C. The STA C may then adjust the WLAN clock of the STA C so that the WLAN clock of the STA C reduces the at least one timing difference between the WLAN clock of the AP and the WLAN clock of the STA C. In this manner, the WLAN clock of the AP and the WLAN clock of the STA C are synchronized by the STA C.

The STA C may also compare the captured media timestamp with the captured TOA timestamp for the FTM packet, FTM+Audio A. By comparing the captured media timestamp with the captured TOA timestamp, the STA C is configured to determine at least one timing difference between the media clock of the STA C and the WLAN clock of the STA C. The STA C may then adjust the media clock of the STA C so that the media clock of the STA C reduces the at least one timing difference between the media clock of the STA C and the WLAN clock of the STA C. In this manner, the media clock of the STA C and the WLAN clock of the STA C are synchronized by the STA C.

The timing differences between the WLAN clock of the AP and the WLAN clock of the STA C may be given in PPM and may include a clock offset, represented by B and a frequency scaling factor represented by M. For example, through repeated triggering and analysis, the STA C is configured to determine the frequency scaling factor M between the WLAN clock in the AP and the WLAN clock of the STA C as well as the clock offset B. In one aspect, the TOA timestamp, WL(STA C) may be related to the TOD timestamp WL(AP) by the formula, WL(STA C)=M(WL(AP))+B. As such, the STA C may adjust the WLAN clock of the STA C to match the frequency and the clock offset of the WLAN clock of the AP based on the M and B calculated in accordance with the TOA timestamp and the TOD timestamp.

The timing differences between the media clock of the STA C and the WLAN clock of the STA C may be given in PPM and may include a clock offset, represented by B and a frequency scaling factor represented by M. For example, through repeated triggering and analysis, the STA C is configured to determine the frequency scaling factor M between the WLAN clock in the STA C and the media clock of the STA C as well as the clock offset B. In one aspect, the media timestamp, Audio(STA C) may be related to the TOA timestamp WL(STA C) by the formula, Audio(STA C)=M(WL(STA C))+B. As such, the STA C may adjust the media clock of the STA C to match the frequency and the clock offset of the WLAN clock of the STA C based on the M and B calculated in accordance with the TOA timestamp and the media timestamp.

The STA D is configured to receive the FTM packet, FTM+Audio C, from the AP. Because the STA D is in the promiscuous mode, the destination address in the header of the FTM packet, FTM+Audio C is irrelevant. The STA D may then compare the extracted TOD timestamp, ts1 (which was for the FTM packet, FTM+Audio A), with the captured TOA timestamp, which was captured and held in response to receiving the FTM packet, FTM+Audio A. By comparing the extracted TOD timestamp, ts1, with the captured TOA timestamp, the STA D is configured to determine at least one timing difference between the WLAN clock of the AP and the WLAN clock of the STA D. The STA D may then adjust the WLAN clock of the STA D so that the WLAN clock of the STA D reduces the at least one timing difference between the WLAN clock of the AP and the WLAN clock of the STA D. In this manner, the WLAN clock of the AP and the WLAN clock of the STA D are synchronized by the STA D.

The STA D may also compare the captured media timestamp with the captured TOA timestamp for the FTM packet, FTM+Audio A. By comparing the captured media timestamp with the captured TOA timestamp, the STA D is configured to determine at least one timing difference between the media clock of the STA D and the WLAN clock of the STA D. The STA D may then adjust the media clock of the STA D so that the media clock of the STA D reduces the at least one timing difference between the media clock of the STA D and the WLAN clock of the STA D. In this manner, the media clock of the STA D and the WLAN clock of the STA D are synchronized by the STA D.

The timing differences between the WLAN clock of the AP and the WLAN clock of the STA D may be given in PPM and may include a clock offset, represented by B and a frequency scaling factor represented by M. For example, through repeated triggering and analysis, the STA D is configured to determine the frequency scaling factor M between the WLAN clock in the AP and the WLAN clock of the STA D as well as the clock offset B. In one aspect, the TOA timestamp, WL(STA D) may be related to the TOD timestamp WL(AP) by the formula, WL(STA D)=M(WL(AP))+B. As such, the STA D may adjust the WLAN clock of the STA D to match the frequency and the clock offset of the WLAN clock of the AP based on the M and B calculated in accordance with the TOA timestamp and the TOD timestamp.

The timing differences between the media clock of the STA D and the WLAN clock of the STA D may be given in PPM and may include a clock offset, represented by B and a frequency scaling factor represented by M. For example, through repeated triggering and analysis, the STA D is configured to determine the frequency scaling factor M between the WLAN clock in the STA D and the media clock of the STA D as well as the clock offset B. In one aspect, the media timestamp, Audio(STA D) may be related to the TOA timestamp WL(STA D) by the formula, Audio(STA D)=M(WL(STA D))+B. As such, the STA D may adjust the media clock of the STA D to match the frequency and the clock offset of the WLAN clock of the STA D based on the M and B calculated in accordance with the TOA timestamp and the media timestamp.

Next, the AP is configured to embed the TOD timestamp for the FTM packet, FTM+Audio B, into the FTM packet FTM+Audio D. In addition, the AP is configured to embed audio data for the STA D into the FTM packet FTM+Audio D. The AP is configured to transmit the FTM packet, FTM+Audio D from the AP to the STA D, but the FTM packet FTM+Audio D may be received by STA A, STA B, and STA C if they are configured in the promiscuous mode. In one aspect, Audio D may include a media timestamp associated with the audio data of Audio D. The media timestamp may be captured by sampling a timestamp counter generated by the media clock of the AP.

The STA A is configured to receive the FTM packet, FTM+Audio D, from the AP. Because the STA A is in the promiscuous mode, the destination address in the header of the FTM packet, FTM+Audio D is irrelevant. The STA A may then compare the extracted TOD timestamp, ts2 (which was for the FTM packet, FTM+Audio B), with the captured TOA timestamp, which was captured and held in response to receiving the FTM packet, FTM+Audio B. By comparing the extracted TOD timestamp, ts2, with the captured TOA timestamp, the STA A is configured to determine at least one timing difference between the WLAN clock of the AP and the WLAN clock of the STA A. The STA A may then adjust the WLAN clock of the STA A so that the WLAN clock of the STA A reduces the at least one timing difference between the WLAN clock of the AP and the WLAN clock of the STA A. In this manner, the WLAN clock of the AP and the WLAN clock of the STA A are synchronized by the STA A.

The STA A may also compare the captured media timestamp with the captured TOA timestamp for the FTM packet, FTM+Audio B. By comparing the captured media timestamp with the captured TOA timestamp, the STA A is configured to determine at least one timing difference between the media clock of the STA A and the WLAN clock of the STA A. The STA A may then adjust the media clock of the STA A so that the media clock of the STA A reduces the at least one timing difference between the media clock of the STA A and the WLAN clock of the STA A. In this manner, the media clock of the STA A and the WLAN clock of the STA A are synchronized by the STA A.

The timing differences between the WLAN clock of the AP and the WLAN clock of the STA A may be given in PPM and may include a clock offset, represented by B and a frequency scaling factor represented by M. For example, through repeated triggering and analysis, the STA A is configured to determine the frequency scaling factor M between the WLAN clock in the AP and the WLAN clock of the STA A as well as the clock offset B. In one aspect, the TOA timestamp, WL(STA A) may be related to the TOD timestamp WL(AP) by the formula, WL(STA A)=M(WL(AP))+B. As such, the STA A may adjust the WLAN clock of the STA A to match the frequency and the clock offset of the WLAN clock of the AP based on the M and B calculated in accordance with the TOA timestamp and the TOD timestamp.

The timing differences between the media clock of the STA A and the WLAN clock of the STA A may be given in PPM and may include a clock offset, represented by B and a frequency scaling factor represented by M. For example, through repeated triggering and analysis, the STA A is configured to determine the frequency scaling factor M between the WLAN clock in the STA A and the media clock of the STA A as well as the clock offset B. In one aspect, the media timestamp, Audio(STA A) may be related to the TOA timestamp WL(STA A) by the formula, Audio(STA A)=M(WL(STA A))+B. As such, the STA A may adjust the media clock of the STA A to match the frequency and the clock offset of the WLAN clock of the STA A based on the M and B calculated in accordance with the TOA timestamp and the media timestamp.

The STA B is configured to receive the FTM packet, FTM+Audio D, from the AP. Since the STA B is in the promiscuous mode, the destination address in the header of the FTM packet, FTM+Audio D is irrelevant. The STA B may then compare the extracted TOD timestamp, ts2 (which was for the FTM packet, FTM+Audio B), with the captured TOA timestamp, which was captured and held in response to receiving the FTM packet, FTM+Audio B. By comparing the extracted TOD timestamp, ts2, with the captured TOA timestamp, the STA B is configured to determine at least one timing difference between the WLAN clock of the AP and the WLAN clock of the STAB. The STA B may then adjust the WLAN clock of the STA B so that the WLAN clock of the STA B reduces the at least one timing difference between the WLAN clock of the AP and the WLAN clock of the STAB. In this manner, the WLAN clock of the AP and the WLAN clock of the STA B are synchronized by the STA B.

The STA B may also compare the captured media timestamp with the captured TOA timestamp for the FTM packet, FTM+Audio B. By comparing the captured media timestamp with the captured TOA timestamp, the STA B is configured to determine at least one timing difference between the media clock of the STA B and the WLAN clock of the STA B. The STA B may then adjust the media clock of the STA B so that the media clock of the STA B reduces the at least one timing difference between the media clock of the STA B and the WLAN clock of the STAB. In this manner, the media clock of the STA B and the WLAN clock of the STA B are synchronized by the STA B.

The timing differences between the WLAN clock of the AP and the WLAN clock of the STA B may be given in PPM and may include a clock offset, represented by B and a frequency scaling factor represented by M. For example, through repeated triggering and analysis, the STA B is configured to determine the frequency scaling factor M between the WLAN clock in the AP and the WLAN clock of the STA B as well as the clock offset B. In one aspect, the TOA timestamp, WL(STA B) may be related to the TOD timestamp WL(AP) by the formula, WL(STA B)=M(WL(AP))+B. As such, the STA B may adjust the WLAN clock of the STA B to match the frequency and the clock offset of the WLAN clock of the AP based on the M and B calculated in accordance with the TOA timestamp and the TOD timestamp.

The timing differences between the media clock of the STA B and the WLAN clock of the STA B may be given in PPM and may include a clock offset, represented by B and a frequency scaling factor represented by M. For example, through repeated triggering and analysis, the STA B is configured to determine the frequency scaling factor M between the WLAN clock in the STA B and the media clock of the STA B as well as the clock offset B. In one aspect, the media timestamp, Audio(STA B) may be related to the TOA timestamp WL(STA B) by the formula, Audio(STA B)=M(WL(STA B))+B. As such, the STA B may adjust the media clock of the STA B to match the frequency and the clock offset of the WLAN clock of the STA B based on the M and B calculated in accordance with the TOA timestamp and the media timestamp.

The STA C is configured to receive the FTM packet, FTM+Audio D, from the AP. Because the STA C is in the promiscuous mode, the destination address in the header of the FTM packet, FTM+Audio D is irrelevant. The STA C may then compare the extracted TOD timestamp, ts2 (which was for the FTM packet, FTM+Audio B), with the captured TOA timestamp, which was captured and held in response to receiving the FTM packet, FTM+Audio B. By comparing the extracted TOD timestamp, ts2, with the captured TOA timestamp, the STA C is configured to determine at least one timing difference between the WLAN clock of the AP and the WLAN clock of the STA C. The STA C may then adjust the WLAN clock of the STA C so that the WLAN clock of the STA C reduces the at least one timing difference between the WLAN clock of the AP and the WLAN clock of the STA C. In this manner, the WLAN clock of the AP and the WLAN clock of the STA C are synchronized by the STA C.

The STA C may also compare the captured media timestamp with the captured TOA timestamp for the FTM packet, FTM+Audio B. By comparing the captured media timestamp with the captured TOA timestamp, the STA C is configured to determine at least one timing difference between the media clock of the STA C and the WLAN clock of the STA C. The STA C may then adjust the media clock of the STA C so that the media clock of the STA C reduces the at least one timing difference between the media clock of the STA C and the WLAN clock of the STA C. In this manner, the media clock of the STA C and the WLAN clock of the STA C are synchronized by the STA C.

The timing differences between the WLAN clock of the AP and the WLAN clock of the STA C may be given in PPM and may include a clock offset, represented by B and a frequency scaling factor represented by M. For example, through repeated triggering and analysis, the STA C is configured to determine the frequency scaling factor M between the WLAN clock in the AP and the WLAN clock of the STA C as well as the clock offset B. In one aspect, the TOA timestamp, WL(STA C) may be related to the TOD timestamp WL(AP) by the formula, WL(STA C)=M(WL(AP))+B. As such, the STA C may adjust the WLAN clock of the STA C to match the frequency and the clock offset of the WLAN clock of the AP based on the M and B calculated in accordance with the TOA timestamp and the TOD timestamp.

The timing differences between the media clock of the STA C and the WLAN clock of the STA C may be given in PPM and may include a clock offset, represented by B and a frequency scaling factor represented by M. For example, through repeated triggering and analysis, the STA C is configured to determine the frequency scaling factor M between the WLAN clock in the STA C and the media clock of the STA C as well as the clock offset B. In one aspect, the media timestamp, Audio(STA C) may be related to the TOA timestamp WL(STA C) by the formula, Audio(STA C)=M(WL(STA C))+B. As such, the STA C may adjust the media clock of the STA C to match the frequency and the clock offset of the WLAN clock of the STA C based on the M and B calculated in accordance with the TOA timestamp and the media timestamp.

The STA D is configured to receive the FTM packet, FTM+Audio D, from the AP. Since the STA D is in the promiscuous mode, the destination address in the header of the FTM packet, FTM+Audio D is irrelevant. The STA D may then compare the extracted TOD timestamp, ts2 (which was for the FTM packet, FTM+Audio B), with the captured TOA timestamp, which was captured and held in response to receiving the FTM packet, FTM+Audio B. By comparing the extracted TOD timestamp, ts2, with the captured TOA timestamp, the STA D is configured to determine at least one timing difference between the WLAN clock of the AP and the WLAN clock of the STA D. The STA D may then adjust the WLAN clock of the STA D so that the WLAN clock of the STA D reduces the at least one timing difference between the WLAN clock of the AP and the WLAN clock of the STA D. In this manner, the WLAN clock of the AP and the WLAN clock of the STA D are synchronized by the STA D.

The STA D may also compare the captured media timestamp with the captured TOA timestamp for the FTM packet, FTM+Audio B. By comparing the captured media timestamp with the captured TOA timestamp, the STA D is configured to determine at least one timing difference between the media clock of the STA D and the WLAN clock of the STA D. The STA D may then adjust the media clock of the STA D so that the media clock of the STA D reduces the at least one timing difference between the media clock of the STA D and the WLAN clock of the STA D. In this manner, the media clock of the STA D and the WLAN clock of the STA D are synchronized by the STA D.

The timing differences between the WLAN clock of the AP and the WLAN clock of the STA D may be given in PPM and may include a clock offset, represented by B and a frequency scaling factor represented by M. For example, through repeated triggering and analysis, the STA D is configured to determine the frequency scaling factor M between the WLAN clock in the AP and the WLAN clock of the STA D as well as the clock offset B. In one aspect, the TOA timestamp, WL(STA D) may be related to the TOD timestamp WL(AP) by the formula, WL(STA D)=M(WL(AP))+B. As such, the STA D may adjust the WLAN clock of the STA D to match the frequency and the clock offset of the WLAN clock of the AP based on the M and B calculated in accordance with the TOA timestamp and the TOD timestamp.

The timing differences between the media clock of the STA D and the WLAN clock of the STA D may be given in PPM and may include a clock offset, represented by B and a frequency scaling factor represented by M. For example, through repeated triggering and analysis, the STA D is configured to determine the frequency scaling factor M between the WLAN clock in the STA D and the media clock of the STA D as well as the clock offset B. In one aspect, the media timestamp, Audio(STA D) may be related to the TOA timestamp WL(STA D) by the formula, Audio(STA D)=M(WL(STA D))+B. As such, the STA D may adjust the media clock of the STA D to match the frequency and the clock offset of the WLAN clock of the STA D based on the M and B calculated in accordance with the TOA timestamp and the media timestamp.

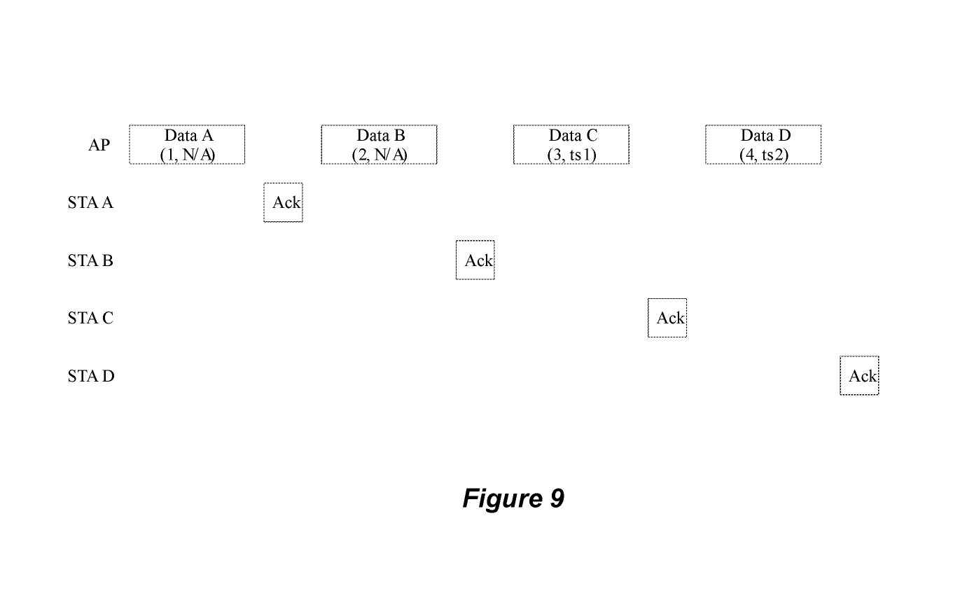

FIG. 9 is an example operational diagram 900 related to one configuration for providing synchronization between the devices in the WLAN network. The WLAN network shown in FIG. 9 includes the AP and the various STAs. More specifically, the WLAN network includes the STA A, the STAB, the STA C, the STA D. The devices of the WLAN network are listed in a vertical progression of the operational diagram 900 starting with the AP and then progressing through the various STA, starting with the STA A and ending with the STA D in alphabetical order. The horizontal progression in the operational diagram represents a temporal axis so that a vertical position of different messages are listed beside the particular device that transmits the message while their horizontal position represents a temporal association of the message relative to the other messages transmitted by the devices.

In the implementation shown in FIG. 9, the STA A, STA B, STA C and STA D are all placed in the promiscuous mode. When any one of the STA A, STA B, STA C or STA D are placed in the promiscuous mode, the STA A, STA B, STA C or STA D are configured to receive and process any of the packets directed to any of the other STAs. In this implementation, there are two synchronization events.

More specifically, the AP in FIG. 9 is configured to transmit a data packet, Data A, from the AP to the STA A. The AP is configured to capture a TOD timestamp, ts1, in response to transmitting the data packet, Data A. However, note that the TOD timestamp, ts1, is not embedded in the data packet, Data A. Instead of attempting to embed the TOD timestamp, is 1, in the data packet, Data A, the AP holds the TOD timestamp, is 1, for later transmission. The data packet Data A is associated with a token 1, as shown in FIG. 9. In this implementation, the AP may be configured to embed audio data into the data packet, Data A directed to the STA A. At this point, the STA A may however not be capable of providing synchronization with the WLAN clock of the AP since the STA A has not received the TOD timestamp, ts1. In one aspect, Data A may include a media timestamp associated with the audio data of Data A. The media timestamp may be captured by sampling a timestamp counter generated by the media clock of the AP.

Furthermore, the AP in FIG. 9 is configured to transmit a data packet, Data B, from the AP to the STAB. The AP is configured to capture a TOD timestamp, ts2, in response to transmitting the data packet, Data B. However, note that the TOD timestamp, ts2, is not embedded in the data packet, Data B. Instead of attempting to embed the TOD timestamp, ts2, in the data packet, Data B, the AP holds the TOD timestamp, ts2, for later transmission. The data packet Data B is associated with a token 2, as shown in FIG. 9. In this implementation, the AP may be configured to embed audio data into the data packet, Data B directed to the STAB. In one aspect, Data B may include a media timestamp associated with the audio data of Data B. The media timestamp may be captured by sampling a timestamp counter generated by the media clock of the AP.

The STA A is configured to receive the data packet, Data A, at the STA A from the AP. Because the STA A is provided in the promiscuous mode, the destination address in the header of the data packet, Data A is irrelevant. The STA A is configured to capture a TOA timestamp in response to receiving the data packet, Data A, from the AP. Additionally, in response to receiving the data packet, Data A, the STA A may also capture a media timestamp from the media clock of the STA A.

The STA B is configured to receive the data packet, Data A, at the STA B from the AP. Since the STA B is provided in the promiscuous mode, the destination address in the header of the data packet, Data A is irrelevant. The STA B is configured to capture a TOA timestamp in response to receiving the data packet, Data A, from the AP. Additionally, in response to receiving the data packet, Data A, the STA B may also capture a media timestamp from the media clock of the STA B.

The STA C is configured to receive the data packet, Data A, at the STA C from the AP. Because the STA C is provided in the promiscuous mode, the destination address in the header of the data packet, Data A is irrelevant. The STA C is configured to capture a TOA timestamp in response to receiving the data packet, Data A, from the AP. Additionally, in response to receiving the data packet, Data A, the STA C may also capture a media timestamp from the media clock of the STA C.

The STA D is configured to receive the data packet, Data A, at the STA D from the AP. Because the STA D is provided in the promiscuous mode, the destination address in the header of the data packet, Data A is irrelevant. The STA D is configured to capture a TOA timestamp in response to receiving the data packet, Data A, from the AP. Additionally, in response to receiving the data packet, Data A, the STA D may also capture a media timestamp from the media clock of the of the STA D.

Furthermore, the AP is configured to embed the TOD timestamp for the data packet, Data A, into the data packet Data C. In addition, the AP is configured to embed audio data for the STA C into the data packet Data C. The AP is configured to transmit the data packet, Data C from the AP to the STA C, but the data packet Data C may be received by STA A, STAB, and STA D if they are configured in the promiscuous mode. The data packet, Data C is associated with a token 3. In one aspect, Data C may include a media timestamp associated with the audio data of Data C. The media timestamp may be captured by sampling a timestamp counter generated by the media clock of the AP.

The STA A is configured to receive the data packet, Data C, from the AP. Because the STA A is in the promiscuous mode, the destination address in the header of the data packet, Data C is irrelevant. The STA A may then compare the extracted TOD timestamp, ts1 (which was for the data packet, Data A), with the captured TOA timestamp, which was captured and held in response to receiving the data packet, Data A. By comparing the extracted TOD timestamp, ts1, with the captured TOA timestamp, the STA A is configured to determine at least one timing difference between the WLAN clock of the AP and the WLAN clock of the STA A. The STA A may then adjust the WLAN clock of the STA A so that the WLAN clock of the STA A reduces the at least one timing difference between the WLAN clock of the AP and the WLAN clock of the STA A. In this manner, the WLAN clock of the AP and the WLAN clock of the STA A are synchronized by the STA A.

The STA A may also compare the captured media timestamp with the captured TOA timestamp for the data packet, Data A. By comparing the captured media timestamp with the captured TOA timestamp, the STA A is configured to determine at least one timing difference between the media clock of the STA A and the WLAN clock of the STA A. The STA A may then adjust the media clock of the STA A so that the media clock of the STA A reduces the at least one timing difference between the media clock of the STA A and the WLAN clock of the STA A. In this manner, the media clock of the STA A and the WLAN clock of the STA A are synchronized by the STA A.

The timing differences between the WLAN clock of the AP and the WLAN clock of the STA A may be given in PPM and may include a clock offset, represented by B and a frequency scaling factor represented by M. For example, through repeated triggering and analysis, the STA A is configured to determine the frequency scaling factor M between the WLAN clock in the AP and the WLAN clock of the STA A as well as the clock offset B. In one aspect, the TOA timestamp, WL(STA A) may be related to the TOD timestamp WL(AP) by the formula, WL(STA A)=M(WL(AP))+B. As such, the STA A may adjust the WLAN clock of the STA A to match the frequency and the clock offset of the WLAN clock of the AP based on the M and B calculated in accordance with the TOA timestamp and the TOD timestamp.

The timing differences between the media clock of the STA A and the WLAN clock of the STA A may be given in PPM and may include a clock offset, represented by B and a frequency scaling factor represented by M. For example, through repeated triggering and analysis, the STA A is configured to determine the frequency scaling factor M between the WLAN clock in the STA A and the media clock of the STA A as well as the clock offset B. In one aspect, the media timestamp, Audio(STA A) may be related to the TOA timestamp WL(STA A) by the formula, Audio(STA A)=M(WL(STA A))+B. As such, the STA A may adjust the media clock of the STA A to match the frequency and the clock offset of the WLAN clock of the STA A based on the M and B calculated in accordance with the TOA timestamp and the media timestamp.

The STA B is configured to receive the data packet, Data C, from the AP. Because the STA B is in the promiscuous mode, the destination address in the header of the data packet, Data C is irrelevant. The STA B may then compare the extracted TOD timestamp, ts1 (which was for the data packet, Data A), with the captured TOA timestamp, which was captured and held in response to receiving the data packet, Data A. By comparing the extracted TOD timestamp, ts1, with the captured TOA timestamp, the STA B is configured to determine at least one timing difference between the WLAN clock of the AP and the WLAN clock of the STA B. The STA B may then adjust the WLAN clock of the STA B so that the WLAN clock of the STA B reduces the at least one timing difference between the WLAN clock of the AP and the WLAN clock of the STAB. In this manner, the WLAN clock of the AP and the WLAN clock of the STA B are synchronized by the STA B.

The STA B may also compare the captured media timestamp with the captured TOA timestamp for the data packet, Data A. By comparing the captured media timestamp with the captured TOA timestamp, the STA B is configured to determine at least one timing difference between the media clock of the STA B and the WLAN clock of the STA B. The STA B may then adjust the media clock of the STA B so that the media clock of the STA B reduces the at least one timing difference between the media clock of the STA B and the WLAN clock of the STA B. In this manner, the media clock of the STA B and the WLAN clock of the STA B are synchronized by the STA B.

The timing differences between the WLAN clock of the AP and the WLAN clock of the STA B may be given in PPM and may include a clock offset, represented by B and a frequency scaling factor represented by M. For example, through repeated triggering and analysis, the STA B is configured to determine the frequency scaling factor M between the WLAN clock in the AP and the WLAN clock of the STA B as well as the clock offset B. In one aspect, the TOA timestamp, WL(STA B) may be related to the TOD timestamp WL(AP) by the formula, WL(STA B)=M(WL(AP))+B. As such, the STA B may adjust the WLAN clock of the STA B to match the frequency and the clock offset of the WLAN clock of the AP based on the M and B calculated in accordance with the TOA timestamp and the TOD timestamp.

The timing differences between the media clock of the STA B and the WLAN clock of the STA B may be given in PPM and may include a clock offset, represented by B and a frequency scaling factor represented by M. For example, through repeated triggering and analysis, the STA B is configured to determine the frequency scaling factor M between the WLAN clock in the STA B and the media clock of the STA B as well as the clock offset B. In one aspect, the media timestamp, Audio(STA B) may be related to the TOA timestamp WL(STA B) by the formula, Audio(STA B)=M(WL(STA B))+B. As such, the STA B may adjust the media clock of the STA B to match the frequency and the clock offset of the WLAN clock of the STA B based on the M and B calculated in accordance with the TOA timestamp and the media timestamp.

The STA C is configured to receive the data packet, Data C, from the AP. Because the STA C is in the promiscuous mode, the destination address in the header of the data packet, Data C is irrelevant. The STA C may then compare the extracted TOD timestamp, ts1 (which was for the data packet, Data A), with the captured TOA timestamp, which was captured and held in response to receiving the data packet, Data A. By comparing the extracted TOD timestamp, ts1, with the captured TOA timestamp, the STA C is configured to determine at least one timing difference between the WLAN clock of the AP and the WLAN clock of the STA C. The STA C may then adjust the WLAN clock of the STA C so that the WLAN clock of the STA C reduces the at least one timing difference between the WLAN clock of the AP and the WLAN clock of the STA C. In this manner, the WLAN clock of the AP and the WLAN clock of the STA C are synchronized by the STA C.

The STA C may also compare the captured media timestamp with the captured TOA timestamp for the data packet, Data A. By comparing the captured media timestamp with the captured TOA timestamp, the STA C is configured to determine at least one timing difference between the media clock of the STA C and the WLAN clock of the STA C. The STA C may then adjust the media clock of the STA C so that the media clock of the STA C reduces the at least one timing difference between the media clock of the STA C and the WLAN clock of the STA C. In this manner, the media clock of the STA C and the WLAN clock of the STA C are synchronized by the STA C.

The timing differences between the WLAN clock of the AP and the WLAN clock of the STA C may be given in PPM and may include a clock offset, represented by B and a frequency scaling factor represented by M. For example, through repeated triggering and analysis, the STA C is configured to determine the frequency scaling factor M between the WLAN clock in the AP and the WLAN clock of the STA C as well as the clock offset B. In one aspect, the TOA timestamp, WL(STA C) may be related to the TOD timestamp WL(AP) by the formula, WL(STA C)=M(WL(AP))+B. As such, the STA C may adjust the WLAN clock of the STA C to match the frequency and the clock offset of the WLAN clock of the AP based on the M and B calculated in accordance with the TOA timestamp and the TOD timestamp.

The timing differences between the media clock of the STA C and the WLAN clock of the STA C may be given in PPM and may include a clock offset, represented by B and a frequency scaling factor represented by M. For example, through repeated triggering and analysis, the STA C is configured to determine the frequency scaling factor M between the WLAN clock in the STA C and the media clock of the STA C as well as the clock offset B. In one aspect, the media timestamp, Audio(STA C) may be related to the TOA timestamp WL(STA C) by the formula, Audio(STA C)=M(WL(STA C))+B. As such, the STA C may adjust the media clock of the STA C to match the frequency and the clock offset of the WLAN clock of the STA C based on the M and B calculated in accordance with the TOA timestamp and the media timestamp.

The STA D is configured to receive the data packet, Data C, from the AP. Because the STA D is in the promiscuous mode, the destination address in the header of the data packet, Data C is irrelevant. The STA D may then compare the extracted TOD timestamp, ts1 (which was for the data packet, Data A), with the captured TOA timestamp, which was captured and held in response to receiving the data packet, Data A. By comparing the extracted TOD timestamp, ts1, with the captured TOA timestamp, the STA D is configured to determine at least one timing difference between the WLAN clock of the AP and the WLAN clock of the STA D. The STA D may then adjust the WLAN clock of the STA D so that the WLAN clock of the STA D reduces the at least one timing difference between the WLAN clock of the AP and the WLAN clock of the STA D. In this manner, the WLAN clock of the AP and the WLAN clock of the STA D are synchronized by the STA D.

The STA D may also compare the captured media timestamp with the captured TOA timestamp for the data packet, Data A. By comparing the captured media timestamp with the captured TOA timestamp, the STA D is configured to determine at least one timing difference between the media clock of the STA D and the WLAN clock of the STA D. The STA D may then adjust the media clock of the STA D so that the media clock of the STA D reduces the at least one timing difference between the media clock of the STA D and the WLAN clock of the STA D. In this manner, the media clock of the STA D and the WLAN clock of the STA D are synchronized by the STA D.

The timing differences between the WLAN clock of the AP and the WLAN clock of the STA D may be given in PPM and may include a clock offset, represented by B and a frequency scaling factor represented by M. For example, through repeated triggering and analysis, the STA D is configured to determine the frequency scaling factor M between the WLAN clock in the AP and the WLAN clock of the STA D as well as the clock offset B. In one aspect, the TOA timestamp, WL(STA D) may be related to the TOD timestamp WL(AP) by the formula, WL(STA D)=M(WL(AP))+B. As such, the STA D may adjust the WLAN clock of the STA D to match the frequency and the clock offset of the WLAN clock of the AP based on the M and B calculated in accordance with the TOA timestamp and the TOD timestamp.

The timing differences between the media clock of the STA D and the WLAN clock of the STA D may be given in PPM and may include a clock offset, represented by B and a frequency scaling factor represented by M. For example, through repeated triggering and analysis, the STA D is configured to determine the frequency scaling factor M between the WLAN clock in the STA D and the media clock of the STA D as well as the clock offset B.

In one aspect, the media timestamp, Audio(STA D) may be related to the TOA timestamp WL(STA D) by the formula, Audio(STA D)=M(WL(STA D))+B. As such, the STA D may adjust the media clock of the STA D to match the frequency and the clock offset of the WLAN clock of the STA D based on the M and B calculated in accordance with the TOA timestamp and the media timestamp.

Next, the AP is configured to embed the TOD timestamp for the data packet, Data B, into the data packet Data D. In addition, the AP is configured to embed audio data for the STA D into the data packet Data D. The AP is configured to transmit the data packet, Data D from the AP to the STA D, but the data packet Data D may be received by STA A, STA B, and STA C if they are configured in the promiscuous mode. The data packet, Data D is associated with a token 4. In one aspect, Data D may include a media timestamp associated with the audio data of Audio D. The media timestamp may be captured by sampling a timestamp counter generated by the media clock of the AP.

The STA A is configured to receive the data packet, Data D, from the AP. Because the STA A is in the promiscuous mode, the destination address in the header of the data packet, Data D is irrelevant. The STA A may then compare the extracted TOD timestamp, ts2 (which was for the data packet, Data B), with the captured TOA timestamp, which was captured and held in response to receiving the data packet, Data B. By comparing the extracted TOD timestamp, ts2, with the captured TOA timestamp, the STA A is configured to determine at least one timing difference between the WLAN clock of the AP and the WLAN clock of the STA A. The STA A may then adjust the WLAN clock of the STA A so that the WLAN clock of the STA A reduces the at least one timing difference between the WLAN clock of the AP and the WLAN clock of the STA A. In this manner, the WLAN clock of the AP and the WLAN clock of the STA A are synchronized by the STA A.

The STA A may also compare the captured media timestamp with the captured TOA timestamp for the data packet, Data B. By comparing the captured media timestamp with the captured TOA timestamp, the STA A is configured to determine at least one timing difference between the media clock of the STA A and the WLAN clock of the STA A. The STA A may then adjust the media clock of the STA A so that the media clock of the STA A reduces the at least one timing difference between the media clock of the STA A and the WLAN clock of the STA A. In this manner, the media clock of the STA A and the WLAN clock of the STA A are synchronized by the STA A.

The timing differences between the WLAN clock of the AP and the WLAN clock of the STA A may be given in PPM and may include a clock offset, represented by B and a frequency scaling factor represented by M. For example, through repeated triggering and analysis, the STA A is configured to determine the frequency scaling factor M between the WLAN clock in the AP and the WLAN clock of the STA A as well as the clock offset B. In one aspect, the TOA timestamp, WL(STA A) may be related to the TOD timestamp WL(AP) by the formula, WL(STA A)=M(WL(AP))+B. As such, the STA A may adjust the WLAN clock of the STA A to match the frequency and the clock offset of the WLAN clock of the AP based on the M and B calculated in accordance with the TOA timestamp and the TOD timestamp.

The timing differences between the media clock of the STA A and the WLAN clock of the STA A may be given in PPM and may include a clock offset, represented by B and a frequency scaling factor represented by M. For example, through repeated triggering and analysis, the STA A is configured to determine the frequency scaling factor M between the WLAN clock in the STA A and the media clock of the STA A as well as the clock offset B. In one aspect, the media timestamp, Audio(STA A) may be related to the TOA timestamp WL(STA A) by the formula, Audio(STA A)=M(WL(STA A))+B. As such, the STA A may adjust the media clock of the STA A to match the frequency and the clock offset of the WLAN clock of the STA A based on the M and B calculated in accordance with the TOA timestamp and the media timestamp.

The STA B is configured to receive the data packet, Data D, from the AP. Because the STA B is in the promiscuous mode, the destination address in the header of the data packet, Data D is irrelevant. The STA B may then compare the extracted TOD timestamp, ts2 (which was for the data packet, Data B), with the captured TOA timestamp, which was captured and held in response to receiving the data packet, Data B. By comparing the extracted TOD timestamp, ts2, with the captured TOA timestamp, the STA B is configured to determine at least one timing difference between the WLAN clock of the AP and the WLAN clock of the STA B. The STA B may then adjust the WLAN clock of the STA B so that the WLAN clock of the STA B reduces the at least one timing difference between the WLAN clock of the AP and the WLAN clock of the STAB. In this manner, the WLAN clock of the AP and the WLAN clock of the STA B are synchronized by the STA B.

The STA B may also compare the captured media timestamp with the captured TOA timestamp for the data packet, Data B. By comparing the captured media timestamp with the captured TOA timestamp, the STA B is configured to determine at least one timing difference between the media clock of the STA B and the WLAN clock of the STA B. The STA B may then adjust the media clock of the STA B so that the media clock of the STA B reduces the at least one timing difference between the media clock of the STA B and the WLAN clock of the STA B. In this manner, the media clock of the STA B and the WLAN clock of the STA B are synchronized by the STA B.

The timing differences between the WLAN clock of the AP and the WLAN clock of the STA B may be given in PPM and may include a clock offset, represented by B and a frequency scaling factor represented by M. For example, through repeated triggering and analysis, the STA B is configured to determine the frequency scaling factor M between the WLAN clock in the AP and the WLAN clock of the STA B as well as the clock offset B. In one aspect, the TOA timestamp, WL(STA B) may be related to the TOD timestamp WL(AP) by the formula, WL(STA B)=M(WL(AP))+B. As such, the STA B may adjust the WLAN clock of the STA B to match the frequency and the clock offset of the WLAN clock of the AP based on the M and B calculated in accordance with the TOA timestamp and the TOD timestamp.

The timing differences between the media clock of the STA B and the WLAN clock of the STA B may be given in PPM and may include a clock offset, represented by B and a frequency scaling factor represented by M. For example, through repeated triggering and analysis, the STA B is configured to determine the frequency scaling factor M between the WLAN clock in the STA B and the media clock of the STA B as well as the clock offset B. In one aspect, the media timestamp, Audio(STA B) may be related to the TOA timestamp WL(STA B) by the formula, Audio(STA B)=M(WL(STA B))+B. As such, the STA B may adjust the media clock of the STA B to match the frequency and the clock offset of the WLAN clock of the STA B based on the M and B calculated in accordance with the TOA timestamp and the media timestamp.

The STA C is configured to receive the data packet, Data D, from the AP. Because the STA C is in the promiscuous mode, the destination address in the header of the data packet, Data D is irrelevant. The STA C may then compare the extracted TOD timestamp, ts2 (which was for the data packet, Data B), with the captured TOA timestamp, which was captured and held in response to receiving the data packet, Data B. By comparing the extracted TOD timestamp, ts2, with the captured TOA timestamp, the STA C is configured to determine at least one timing difference between the WLAN clock of the AP and the WLAN clock of the STA C. The STA C may then adjust the WLAN clock of the STA C so that the WLAN clock of the STA C reduces the at least one timing difference between the WLAN clock of the AP and the WLAN clock of the STA C. In this manner, the WLAN clock of the AP and the WLAN clock of the STA C are synchronized by the STA C.

The STA C may also compare the captured media timestamp with the captured TOA timestamp for the data packet, Data B. By comparing the captured media timestamp with the captured TOA timestamp, the STA C is configured to determine at least one timing difference between the media clock of the STA C and the WLAN clock of the STA C. The STA C may then adjust the media clock of the STA C so that the media clock of the STA C reduces the at least one timing difference between the media clock of the STA C and the WLAN clock of the STA C. In this manner, the media clock of the STA C and the WLAN clock of the STA C are synchronized by the STA C.

The timing differences between the WLAN clock of the AP and the WLAN clock of the STA C may be given in PPM and may include a clock offset, represented by B and a frequency scaling factor represented by M. For example, through repeated triggering and analysis, the STA C is configured to determine the frequency scaling factor M between the WLAN clock in the AP and the WLAN clock of the STA C as well as the clock offset B. In one aspect, the TOA timestamp, WL(STA C) may be related to the TOD timestamp WL(AP) by the formula, WL(STA C)=M(WL(AP))+B. As such, the STA C may adjust the WLAN clock of the STA C to match the frequency and the clock offset of the WLAN clock of the AP based on the M and B calculated in accordance with the TOA timestamp and the TOD timestamp.

The timing differences between the media clock of the STA C and the WLAN clock of the STA C may be given in PPM and may include a clock offset, represented by B and a frequency scaling factor represented by M. For example, through repeated triggering and analysis, the STA C is configured to determine the frequency scaling factor M between the WLAN clock in the STA C and the media clock of the STA C as well as the clock offset B. In one aspect, the media timestamp, Audio(STA C) may be related to the TOA timestamp WL(STA C) by the formula, Audio(STA C)=M(WL(STA C))+B. As such, the STA C may adjust the media clock of the STA C to match the frequency and the clock offset of the WLAN clock of the STA C based on the M and B calculated in accordance with the TOA timestamp and the media timestamp.

The STA D is configured to receive the data packet, Data D, from the AP. Because the STA D is in the promiscuous mode, the destination address in the header of the data packet, Data D is irrelevant. The STA D may then compare the extracted TOD timestamp, ts2 (which was for the data packet, Data B), with the captured TOA timestamp, which was captured and held in response to receiving the data packet, Data B. By comparing the extracted TOD timestamp, ts2, with the captured TOA timestamp, the STA D is configured to determine at least one timing difference between the WLAN clock of the AP and the WLAN clock of the STA D. The STA D may then adjust the WLAN clock of the STA D so that the WLAN clock of the STA D reduces the at least one timing difference between the WLAN clock of the AP and the WLAN clock of the STA D. In this manner, the WLAN clock of the AP and the WLAN clock of the STA D are synchronized by the STA D.

The STA D may also compare the captured media timestamp with the captured TOA timestamp for the data packet, Data B. By comparing the captured media timestamp with the captured TOA timestamp, the STA D is configured to determine at least one timing difference between the media clock of the STA D and the WLAN clock of the STA D. The STA D may then adjust the media clock of the STA D so that the media clock of the STA D reduces the at least one timing difference between the media clock of the STA D and the WLAN clock of the STA D. In this manner, the media clock of the STA D and the WLAN clock of the STA D are synchronized by the STA D.

The timing differences between the WLAN clock of the AP and the WLAN clock of the STA D may be given in PPM and may include a clock offset, represented by B and a frequency scaling factor represented by M. For example, through repeated triggering and analysis, the STA D is configured to determine the frequency scaling factor M between the WLAN clock in the AP and the WLAN clock of the STA D as well as the clock offset B. In one aspect, the TOA timestamp, WL(STA D) may be related to the TOD timestamp WL(AP) by the formula, WL(STA D)=M(WL(AP))+B. As such, the STA D may adjust the WLAN clock of the STA D to match the frequency and the clock offset of the WLAN clock of the AP based on the M and B calculated in accordance with the TOA timestamp and the TOD timestamp.

The timing differences between the media clock of the STA D and the WLAN clock of the STA D may be given in PPM and may include a clock offset, represented by B and a frequency scaling factor represented by M. For example, through repeated triggering and analysis, the STA D is configured to determine the frequency scaling factor M between the WLAN clock in the STA D and the media clock of the STA D as well as the clock offset B. In one aspect, the media timestamp, Audio(STA D) may be related to the TOA timestamp WL(STA D) by the formula, Audio(STA D)=M(WL(STA D))+B. As such, the STA D may adjust the media clock of the STA D to match the frequency and the clock offset of the WLAN clock of the STA D based on the M and B calculated in accordance with the TOA timestamp and the media timestamp.

Note that the techniques utilized in FIGS. 6-9 may introduce greater error in clock drift in comparison to the technique disclosed in FIG. 5. However, this may be inconsequential so long as audio synchronization is provided well within error limits. For example, assume there is a +/−20 parts per million (PPM) difference between the AP and the STA and also a +/−5 PPM drift over a 20 milliseconds (ms) interval between short interframe space (SIFS), which is how long it takes for the STA to respond to a packet from the AP. Assuming that a packet duration is 100 microseconds (μs), the TOD timestamp is delivered in the same packet in the implementation shown in FIG. 5 and thus a 10 nanoseconds (ns) error results. However, in the techniques described in FIG. 6-FIG. 9, the last of the STAs may not be able to provide synchronization until after 400 μs, since the temporal duration of 4 times the packets are involved in order for the last of the STAs to receive the TOD timestamp. Accordingly, over the multiple 20 ms SIFS there will be at most 0.2 μs of drift between the WLAN clock of the AP and the WLAN clock of the STA. However, 0.2 μs error in audio synchronization is still well outside anthropic audio perception and thus the increase in error is acceptable.

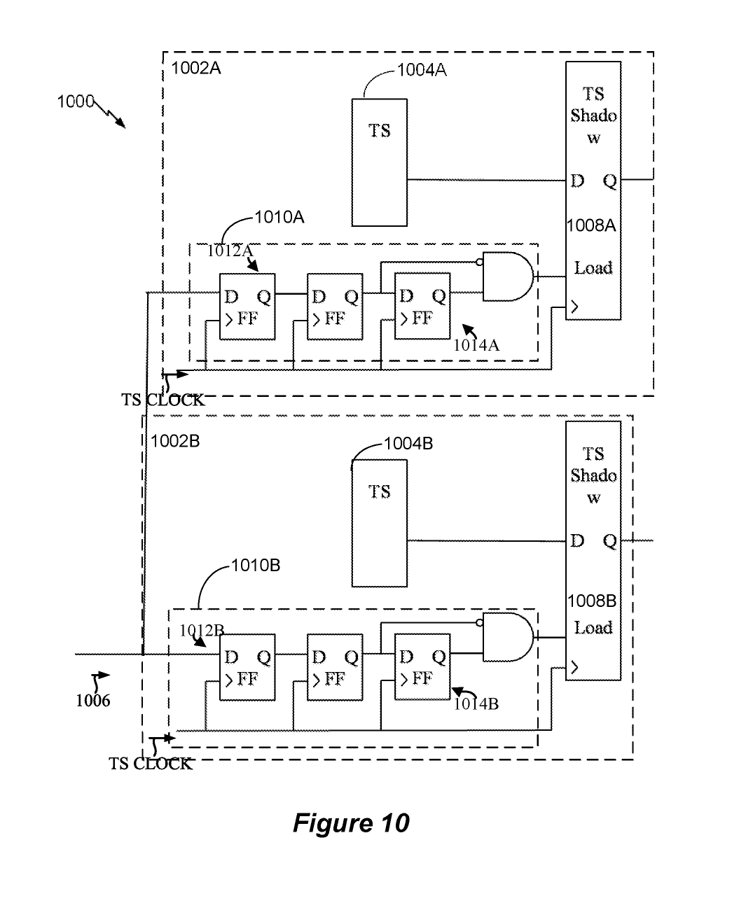

FIG. 10 illustrates an example of an HW capture circuit 1000 configured to capture multiple timestamps from time domains that utilize different systems clocks. For example, a HW capture circuit, like the HW capture circuit 1000 shown in FIG. 10 may be utilized to capture a media timestamp generated from a media clock domain in the AP of FIG. 6-FIG. 9 and a TOD timestamp (i.e., one type of packet timestamp) generated from a WLAN clock domain of the AP in the FIG. 6-FIG. 9 in response to transmitting the data packet or FTM packet to the STAs of FIG. 6-FIG. 9. Furthermore, another HW capture circuit, like the HW capture circuit 1000 shown in FIG. 10, may be utilized to capture a media timestamp generated from a media clock domain in each of the STAs of FIG. 6-FIG. 9 and a TOA timestamp (i.e., another type of packet timestamp) generated from a WLAN clock domain in each of the STAs of FIG. 6-FIG. 9 in response to receiving the data packet or FTM packet at the STAs of FIG. 6-FIG. 9.

In this example, the HW capture circuit 1000 includes a capture sub-circuit 1002A for capturing a media timestamp from a clock register 1004A in response to a timestamp capture signal 1006 being asserted. The timestamp capture signal 1006 is asserted in response to the transmission of a packet in the case of the AP or in response to receiving the packet in the case of each of the STAs, as explained above in FIG. 6-FIG. 9. The clock register 1004A has a clock value that is incremented in response to each of the pulses from a media clock so that the clock value provides a time measurement. The HW capture circuit 1000 includes a shadow register 1008A coupled to the clock register 1004A. Upon assertion of the timestamp capture signal 1006, the clock value that is stored in the clock register 1004A is output to the shadow register 1008A to capture the media timestamp of the media clock.

However, to trigger the shadow register 1008A and capture the media timestamp a single cycle pulse is not used since this pulse may disappear. Instead, a timestamp clock TS Clock is provided to the shadow register 1008A along with an enabling signal ENA that is generated by an edge-triggered circuit 1010A. The edge-triggered circuit 1010A has a pair of sequentially coupled D-flip flops 1012A where the initial D-flip flop is configured to receive and to synchronize the timestamp capture signal 1006 from a General Purpose Input/Output pin (GPIO) to the timestamp clock TS Clock. The pair of sequentially coupled D-flip flops 1012A helps to resolve meta stability. Software that reads the shadow register 1008A can calibrate out the average latency of the pair of sequentially coupled D-flip flops 1012A in the edge-triggered circuit 1010A. The edge-triggered circuit 1010A then includes an edge detector 1014A, which is provided by another D-flip flop and an AND gate. The output from the pair of sequentially coupled D-flip flops 1012A is provided to one input of the AND gate and to the input of the D-flip flop in the edge detector 1014A. The output of the D-flip flop in the edge detector 1014A is provided to the other input of the AND gate. In this case, the input of the AND gate that receives output from the pair of sequentially coupled D-flip flops 1012A is inverted and thus the edge detector 1014A is configured to assert the enabling signal ENA from the output of the AND gate in response to a falling edge in the timestamp capture signal 1006. Alternatively, if the input of the AND gate that received the output of the D-flip flop in the edge detector 1014A were inverted instead of the input of the AND gate that receives the output from the pair of sequentially coupled D-flip flops 1012A, the edge detector 1014A would be configured to assert the enabling signal ENA from the output of the AND gate in response to a rising edge in the timestamp capture signal 1006. In response to the enabling signal ENA being asserted, the shadow register 1008A is configured to store the clock value from the clock register 1004A as the media timestamp.

The HW capture circuit 1000 also includes a capture sub-circuit 1002B for capturing a packet timestamp from a clock register 1004B in response to a timestamp capture signal 1006 being asserted. The timestamp capture signal 1006 is asserted in response to the transmission of a packet in the case of the AP or in response to receiving the packet in the case of each of the STAs, as explained above in FIG. 6-FIG. 9. The clock register 1004B has a clock value that is incremented in response to each of the pulses from a WLAN clock so that the clock value provides a time measurement. The HW capture circuit 1000 includes a shadow register 1008B coupled to the clock register 1004B. Upon assertion of the timestamp capture signal 1006, the clock value that is stored in the clock register 1004B is output to the shadow register 1008B to capture the packet timestamp of the WLAN clock.

However, to trigger the shadow register 1008B and capture the packet timestamp a single cycle pulse is not used since this pulse may disappear. Instead, a timestamp clock TS Clock is provided to the shadow register 1008B along with an enabling signal ENB that is generated by an edge-triggered circuit 1010B. The edge-triggered circuit 1010B has a pair of sequentially coupled D-flip flops 1012B where the initial D-flip flop is configured to receive and to synchronize the timestamp capture signal 1006 from the GPIO to the timestamp clock TS Clock. The pair of sequentially coupled D-flip flops 1012B helps to resolve meta stability. Software that reads the shadow register 1008B can calibrate out the average latency of the pair of sequentially coupled D-flip flops 1012B in the edge-triggered circuit 1010B. The edge-triggered circuit 1010B then includes an edge detector 1014B, which is provided by another D-flip flop and an AND gate. The output from the pair of sequentially coupled D-flip flops 1012B is provided to one input of the AND gate and to the input of the D-flip flop in the edge detector 1014B. The output of the D-flip flop in the edge detector 1014B is provided to the other input of the AND gate. In this case, the input of the AND gate that receives output from the pair of sequentially coupled D-flip flops 1012B is inverted and thus the edge detector 1014B is configured to assert the enabling signal ENB from the output of the AND gate in response to a falling edge in the timestamp capture signal 1006. Alternatively, if the input of the AND gate that received the output of the D-flip flop in the edge detector 1014B were inverted instead of the input of the AND gate that receives the output from the pair of sequentially coupled D-flip flops 1012B, the edge detector 1014B would be configured to assert the enabling signal ENB from the output of the AND gate in response to a rising edge in the timestamp capture signal 1006. In response to the enabling signal ENB being asserted, the shadow register 1008B is configured to store the clock value from the clock register 1004B as the packet timestamp.

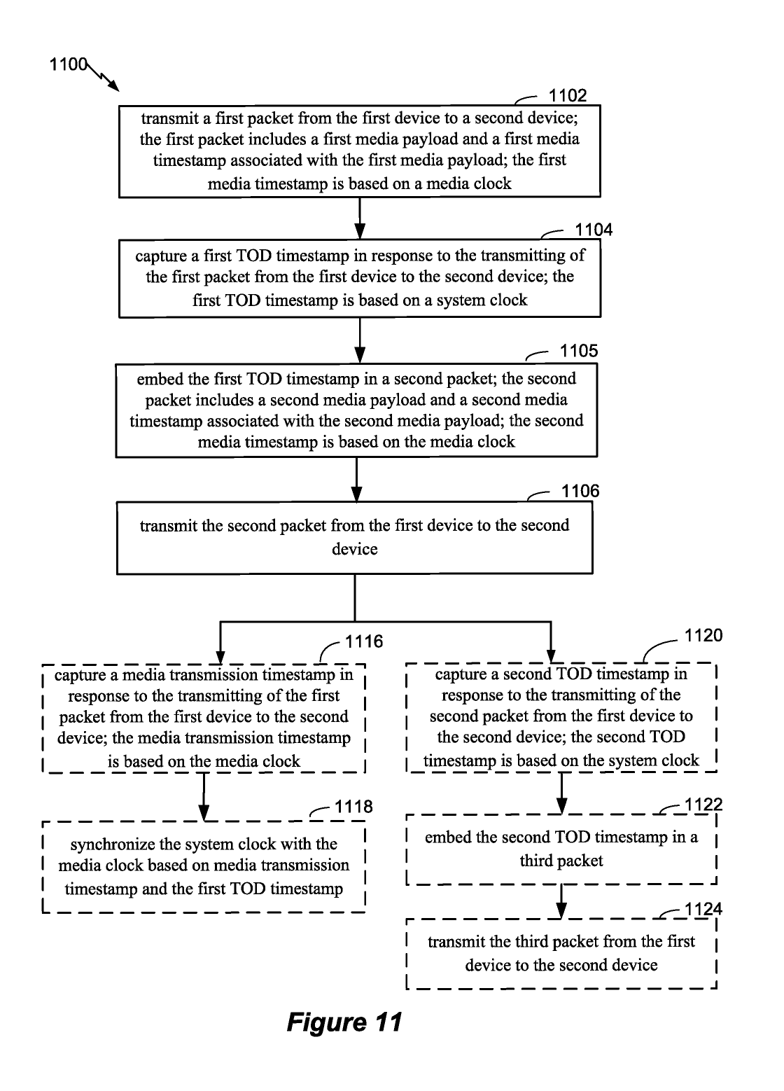

FIG. 11 shows a flowchart 1100 illustrating an example process for wireless communication according to some implementations by a first device, such as a wireless AP. At 1102, the first device transmits a first packet from the first device to a second device. The first packet may include a first media payload such as an audio payload. The first media payload may include a first media timestamp associated with the first media payload. For example, the first media payload may be packetized and the first media timestamp may be embedded within the packetized first media payload. The first media timestamp may be sampled from a media timestamp counter running on a media clock of the first device. The second device may be a wireless STA.

The first device may capture a first TOD timestamp in response to the transmitting of the first packet from the first device to the second device at 1104. The first TOD timestamp may be sampled from a system timestamp counter running on a system clock of the first device. In one aspect, the system clock and the media clock of the first device may be different clock domains. The system clock of the first device may be synchronized with the media clock of the first device using the HW capture circuit of FIG. 10. In one aspect, the system clock may be a WLAN clock of the first device or a WLAN clock of the BSS.

At 1105, the first device embeds the first TOD timestamp into a second packet. The second packet may include a second media payload. The second media payload may include a second media timestamp associated with the second media payload. The second media timestamp may be sampled from the media timestamp counter running on the media clock of the first device. At 1106 the first device may transmit the second packet to the second device.

In some aspects, the first device may further capture a first media transmission timestamp in response to the transmitting of the first packet from the first device to the second device at 1116. The first media transmission timestamp may be sampled from the media timestamp counter running on the media clock of the first device. In one aspect, the first device may capture the first media transmission timestamp using the HW capture circuit of FIG. 10. At 1118, the first device may synchronize the system clock of the first device, such as the WLAN clock, with the media clock based on the first media transmission timestamp and the first TOD timestamp. In one aspect, the first device may synchronize the system clock of the first device with the media clock of the first device by comparing a time offset between the first TOD timestamp and the first media transmission timestamp, and adjusting the media clock to minimize the time offset. In one aspect, the first device may repeatedly capture TOD timestamps and media transmission timestamps in response to the transmitting of each packet from the first device, determine the time offsets between the TOD timestamps and the corresponding media transmission timestamps, and adjust the media clock to minimize the time offsets.

In some aspects, the first device may capture a second TOD timestamp in response to the transmitting of, or associated with the transmission time of, the second packet from the first device to the second device at 1120. The second TOD timestamp may be sampled from the system timestamp counter running on the system clock of the first device. At 1122, the first device may embed the second TOD timestamp into a third packet. At 1124, the first device may transmit the third packet to the second device.

In some aspects, the first device may further capture a second media transmission timestamp in response to the transmitting of the second packet from the first device to the second device. The second media transmission timestamp may be sampled from the media timestamp counter running on the media clock of the first device. The first device may synchronize the system clock of the first device, such as a WLAN clock, with the media clock based on the first media transmission timestamp, the second media transmission timestamp, the first TOD timestamp, and the second TOD timestamp. For example, in the operations depicted in FIGS. 6-9, the first device may compare a time offset between the first TOD timestamp and the first media transmission timestamp to generate a first time offset. The first device may compare a time offset between the second TOD timestamp and the second media transmission timestamp to generate a second time offset. The first device may determine a timestamp offset between the system clock and the media clock of the first device from the first time offset or the second time offset. The first device may further determine a clock frequency offset, or a clock drift, between the system clock and the media clock of the first device by determining the rate of change between the first time offset and the second time offset. The first device may adjust the media clock based on the timestamp offset and the clock frequency offset to synchronize the media clock of the first device to the system clock of the first device.

In one aspect, multimedia data other than audio data, such as video data, may be embedded in the first packet and the second packet. Also, in some aspects, the first packet is a first FTM packet and the second packet is a second FTM packet. In other aspects, the first packet includes a first data packet and the second packet includes a second data packet.

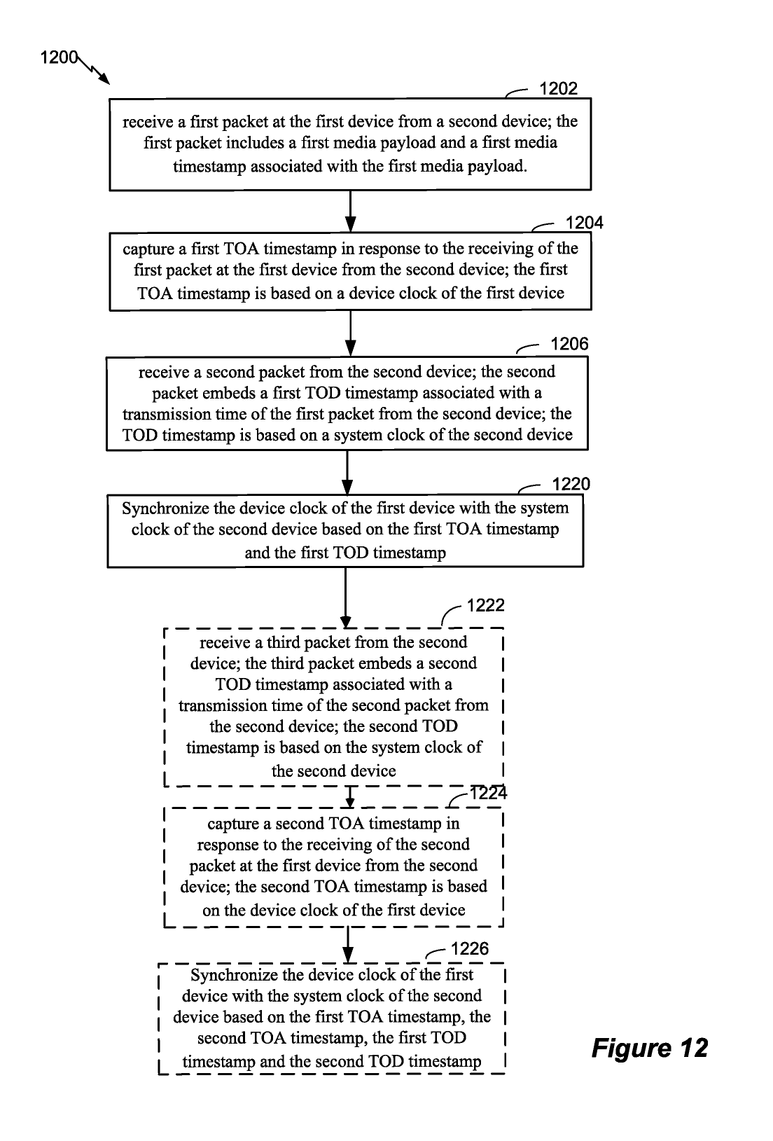

FIG. 12 shows a flowchart 1200 illustrating an example process for wireless communication according to some implementations. At 1202, a first device may receive a first packet at a first device from a second device. The first device may be a wireless STA and the second device may be a wireless AP. The first packet may include a first media payload such as an audio payload. The first media payload may include a first media timestamp associated with the first media payload.

The first device may capture a first TOA timestamp in response to the receiving of the first packet at the first device from the second device at 1204. The first TOA timestamp may be sampled from a system timestamp counter running on a device clock of the first device. In one aspect, the device clock may be a WLAN clock of the first device. In one aspect, the first device may capture the first TOA timestamp using the HW capture circuit of FIG. 10.

At 1206, the first device may receive a second packet from the second device, where a first TOD timestamp is embedded in the second packet. The first TOD timestamp may be associated with a transmission time of the first packet from the second device. The first TOD timestamp may be sampled from a system timestamp counter running on a system clock of the second device. In one aspect, the system clock of the second device may be a WLAN clock of the second device or a WLAN clock of the BSS. The second packet may include a second media payload. The second media payload may include a second media timestamp associated with the second media payload.

In a non-promiscuous mode, the first device may receive the first packet and the second packet only when the packets are addressed to the first device. In a promiscuous mode, the first device may receive the first packet and the second packet from the second device even when the first packet and the second packet are addressed to a different device.

For synchronization, the first device may synchronize the device clock of the first device with the system clock of the second device based on the first TOA timestamp and the first TOD timestamp at 1220. In one aspect, the first device may synchronize the device clock of the first device with the system clock of the second device by comparing a time offset between the TOA timestamp and the TOD timestamp, and adjusting the device clock of the first device to minimize the time offset. In one aspect, the first device may repeatedly capture TOA timestamps in response to receiving multiple packets from the first device, receive TOD timestamps embedded in the multiple packets, determine the time offsets between the TOA timestamps and the corresponding TOD timestamps, and adjust the device clock of the first device to minimize the time offsets.

In one aspect, at 1222, the first device may receive a third packet from the second device, where a second TOD timestamp is embedded in the third packet. The second TOD timestamp may be associated with a transmission time of the second packet from the second device. The second TOD timestamp may be sampled from the system timestamp counter running on the system clock of the second device.

In one aspect, the first device may capture a second TOA timestamp in response to the receiving of the second packet at the first device from the second device at 1224. The second TOA timestamp may be sampled from the system timestamp counter running on the device clock of the first device. In one aspect, the first device may synchronize the device clock of the first device with the system clock of the second device based on the first TOA timestamp, the second TOA timestamp, the first TOD timestamp, and the second TOD timestamp at 1226. For example, in the operations depicted in FIGS. 6-9, the first device may compare a time offset between the first TOA timestamp and the first TOD timestamp to generate a first time offset. The first device may compare a time offset between the second TOA timestamp and the second TOD timestamp to generate a second time offset. The first device may determine a timestamp offset between the device clock of the first device and the system clock of the second device from the first time offset or the second time offset. The first device may further determine a clock frequency offset, or a clock drift, between the device clock of the first device and the system clock of the second device by determining the rate of change between the first time offset and the second time offset. The first device may adjust the device clock of the first device based on the timestamp offset and the clock frequency offset to synchronize the device clock of the first device to the system clock of the second device.

The first device may also capture a first media timestamp in response to the receiving of the first packet at the first device from the second device. The first media timestamp may be sampled from a media timestamp counter running on a media clock of the first device. The first device may also capture a second media timestamp in response to the receiving of the second packet at the first device from the second device. The second media timestamp may also be sampled from the media timestamp counter running on the media clock of the first device. The first device may synchronize the media clock of the first device with the system clock of the second device based on the first media timestamp, the second media timestamp, first TOD timestamp, and the second TOD timestamp. For example, in the operations depicted in FIGS. 6-9, the first device may compare a time offset between the first media timestamp and the first TOD timestamp to generate a first time offset. The first device may compare a time offset between the second media timestamp and the second TOD timestamp to generate a second time offset. The first device may determine a timestamp offset between the media clock of the first device and the system clock of the second device from the first time offset or the second time offset. The first device may further determine a clock frequency offset, or a clock drift, between the media clock of the first device and the system clock of the second device by determining the rate of change between the first time offset and the second time offset. The first device may adjust the media clock of the first device based on the timestamp offset and the clock frequency offset to synchronize the media clock of the first device to the system clock of the second device.

In some aspects, the first packet is a first FTM packet and the second packet is a second FTM packet. In other aspects, the first packet comprises a first data packet and the second packet comprises a second data packet.

As used herein, a phrase referring to “at least one of” or “one or more of” a list of items refers to any combination of those items, including single members. For example, “at least one of: a, b, or c” is intended to cover the possibilities of: a only, b only, c only, a combination of a and b, a combination of a and c, a combination of b and c, and a combination of a and b and c.

The various illustrative components, logic, logical blocks, modules, circuits, operations and algorithm processes described in connection with the implementations disclosed herein may be implemented as electronic hardware, firmware, software, or combinations of hardware, firmware or software, including the structures disclosed in this specification and the structural equivalents thereof. The interchangeability of hardware, firmware and software has been described generally, in terms of functionality, and illustrated in the various illustrative components, blocks, modules, circuits and processes described above. Whether such functionality is implemented in hardware, firmware or software depends upon the particular application and design constraints imposed on the overall system.

The hardware and data processing apparatus used to implement the various illustrative components, logics, logical blocks, modules and circuits described in connection with the aspects disclosed herein may be implemented or performed with a general purpose single- or multi-chip processor, a digital signal processor (DSP), an application specific integrated circuit (ASIC), a field programmable gate array (FPGA) or other programmable logic device (PLD), discrete gate or transistor logic, discrete hardware components, or any combination thereof designed to perform the functions described herein. A general purpose processor may be a microprocessor, or, any conventional processor, controller, microcontroller, or state machine. A processor also may be implemented as a combination of computing devices, for example, a combination of a DSP and a microprocessor, a plurality of microprocessors, one or more microprocessors in conjunction with a DSP core, or any other such configuration. In some implementations, particular processes, operations and methods may be performed by circuitry that is specific to a given function.

As described above, in some aspects implementations of the subject matter described in this specification can be implemented as software. For example, various functions of components disclosed herein or various blocks or steps of a method, operation, process or algorithm disclosed herein can be implemented as one or more modules of one or more computer programs. Such computer programs can include non-transitory processor- or computer-executable instructions encoded on one or more tangible processor- or computer-readable storage media for execution by, or to control the operation of, data processing apparatus including the components of the devices described herein. By way of example, and not limitation, such storage media may include RAM, ROM, EEPROM, CD-ROM or other optical disk storage, magnetic disk storage or other magnetic storage devices, or any other medium that may be used to store program code in the form of instructions or data structures. Combinations of the above should also be included within the scope of storage media.

Various modifications to the implementations described in this disclosure may be readily apparent to persons having ordinary skill in the art, and the generic principles defined herein may be applied to other implementations without departing from the spirit or scope of this disclosure. Thus, the claims are not intended to be limited to the implementations shown herein, but are to be accorded the widest scope consistent with this disclosure, the principles and the novel features disclosed herein.

Additionally, various features that are described in this specification in the context of separate implementations also can be implemented in combination in a single implementation. Conversely, various features that are described in the context of a single implementation also can be implemented in multiple implementations separately or in any suitable subcombination. As such, although features may be described above as acting in particular combinations, and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Further, the drawings may schematically depict one more example processes in the form of a flowchart or flow diagram. However, other operations that are not depicted can be incorporated in the example processes that are schematically illustrated. For example, one or more additional operations can be performed before, after, simultaneously, or between any of the illustrated operations. In some circumstances, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products.

What is claimed is:

1. A method for wireless communication:
receiving a first packet at a first device from a second device, the first packet including a first media payload, the first media payload including a first media timestamp associated with the first media payload;
capturing a first time of arrival (TOA) timestamp in response to receiving the first packet at the first device from the second device, the first TOA timestamp being sampled from a device timestamp incremented by a device clock of the first device; and
receiving a second packet at the first device from the second device, the second packet including a first time of departure (TOD) timestamp associated with a transmission time of the first packet from the second device, the first TOD timestamp being sampled from a system timestamp of the second device incremented by a system clock of the second device, the second packet including a second media payload, the second media payload including a second media timestamp associated with the second media payload; and
synchronizing the device clock of the first device with the system clock of the second device based on the first TOA timestamp and the first TOD timestamp.

2. The method of claim 1, wherein the first packet and the second packet are received by the first device regardless of whether the first packet and the second packet are addressed to the first device by the second device.

3. The method of claim 1, further comprising:
receiving a third packet at the first device from the second device, the third packet including a second TOD timestamp associated with a transmission time of the second packet from the second device, the second TOD timestamp being sampled from the system timestamp of the second device incremented by the system clock of the second device.

4. The method of claim 3, further comprising:
capturing a second TOA timestamp in response to receiving the second packet at the first device from the second device, the second TOA timestamp being sampled from the device timestamp incremented by the device clock of the first device; and
synchronizing the device clock of the first device with the system clock of the second device based on the first TOA timestamp, the second TOA timestamp, the first TOD timestamp, and the second TOD timestamp.

5. The method of claim 4, wherein synchronizing the device clock of the first device with the system clock of the second device comprises measuring a timestamp offset and a clock frequency offset between the device clock of the first device and the system clock of the second device.

6. The method of claim 4, wherein the system clock of the second device comprises a wireless local area network (WLAN) of the second device, and wherein the device clock of the first device comprises a WLAN clock of the first device.

7. The method of claim 3, further comprising:
capturing a first media timestamp of the first device in response to receiving the first packet at the first device from the second device, the first media timestamp being sampled from a media timestamp incremented by a media clock of the first device;
capturing a second media timestamp of the first device in response to receiving the second packet at the first device from the second device, the second media timestamp being sampled from the media timestamp generated by the media clock of the first device; and
synchronizing the media clock of the first device with the system clock of the second device based on the first media timestamp, the second media timestamp, the first TOD timestamp, and the second TOD timestamp.

8. The method of claim 7, wherein synchronizing the media clock of the first device with the system clock of the second device comprises measuring a timestamp offset and a clock frequency offset between the media clock of the first device and the system clock of the second device.

9. The method of claim 1, wherein the first packet comprises a first fine time measurement (FTM) packet and the second packet comprises a second FTM packet.

10. The method of claim 1, wherein the first packet comprises a first data packet and the second packet comprises a second data packet.

11. A method for wireless communication, comprising:
transmitting a first packet from a first device to a second device, the first packet including a first media payload, the first media payload including a first media timestamp associated with the first media payload, the first media timestamp being sampled from a media timestamp incremented by a media clock of the first device;
capturing a first time of departure (TOD) timestamp associated with a transmission time of the first packet, the first TOD timestamp being sampled from a system timestamp incremented by a system clock of the first device;
embedding the first TOD timestamp in a second packet, the second packet including a second media payload, the second media payload including a second media timestamp associated with the second media payload, the second media timestamp being sampled from the media timestamp; and
transmitting the second packet from the first device to the second device.

12. The method of claim 11, further comprising:
capturing a second TOD timestamp associated with a transmission time of the second packet, the second TOD timestamp being sampled from the system timestamp incremented by the system clock of the first device;
embedding the second TOD timestamp in a third packet; and
transmitting the third packet from the first device to the second device.

13. The method of claim 11, wherein the first packet comprises a first fine time measurement (FTM) packet and the second packet comprises a second FTM packet.

14. The method of claim 11, wherein the first packet comprises a first data packet and the second packet comprises a second data packet.

15. The method of claim 11, further comprising:
capturing a media transmission timestamp in response to the transmitting of the first packet from the first device to the second device, the media transmission timestamp being sampled from the media timestamp incremented by the media clock of the first device;
synchronizing the system clock of the first device with the media clock of the first device based on the media transmission timestamp and the first TOD timestamp.

16. An wireless communication device comprising:
at least one antenna;
at least one processor; and
at least one memory communicatively coupled with the at least one processor and storing processor readable code that, when executed by the at least one processor, causes the wireless communication device to:
receive a first packet at the wireless communication device from a second device, the first packet including a first media payload, the first media payload including a first media timestamp associated with the first media payload;
capture a first time of arrival (TOA) timestamp in response to a reception of the first packet at the wireless communication device from the second device, the first TOA timestamp being sampled from a device timestamp incremented by a device clock of the wireless communication device; and
receive a second packet at the wireless communication device from the second device, the second packet including a first time of departure (TOD) timestamp associated with a transmission time of the first packet from the second device, the first TOD timestamp being sampled from a system timestamp of the second device incremented by a system clock of the second device, the second packet including a second media payload, the second media payload including a second media timestamp associated with the second media payload; and
synchronize the device clock of the wireless communication device with the system clock of the second device based on the first TOA timestamp and the first TOD timestamp.

17. The wireless communication device of claim 16, wherein the wireless communication device receives the first packet and the second packet regardless of whether the first packet and the second packet are addressed to the wireless communication device by the second device.

18. The wireless communication device of claim 16, wherein the at least one processor when executing the processor readable code further causes the wireless communication device to:
receive a third packet at the wireless communication device from the second device, the third packet including a second TOD timestamp associated with a transmission time of the second packet from the second device, the second TOD timestamp being sampled from the system timestamp of the second device incremented by the system clock of the second device.

19. The wireless communication device of claim 18, wherein the at least one processor when executing the processor readable code further causes the wireless communication device to:
capture a second TOA timestamp in response to a reception of the second packet at the wireless communication device from the second device, the second TOA timestamp being sampled from the device timestamp incremented by the device clock of the wireless communication device; and
synchronize the device clock of the wireless communication device with the system clock of the second device based on the first TOA timestamp, the second TOA timestamp, the first TOD timestamp, and the second TOD timestamp.

20. The wireless communication device of claim 19, wherein to synchronize the device clock of the wireless communication device with the system clock of the second device, the at least one processor when executing the processor readable code further causes the wireless communication device to measure a timestamp offset and a clock frequency offset between the device clock of the wireless communication device and the system clock of the second device.

21. The wireless communication device of claim 19, wherein the system clock of the second device comprises a wireless local area network (WLAN) of the second device, and wherein the device clock of the wireless communication device comprises a WLAN clock of the wireless communication device.

22. The wireless communication device of claim 18, wherein the at least one processor when executing the processor readable code further causes the wireless communication device to:
capture a first media timestamp of the wireless communication device in response to the reception of the first packet at the wireless communication device from the second device, the first media timestamp being sampled from a media timestamp incremented by a media clock of the wireless communication device;
capture a second media timestamp of the wireless communication device in response to a reception of the second packet at the wireless communication device from the second device, the second media timestamp being sampled from the media timestamp generated by the media clock of the wireless communication device; and
synchronize the media clock of the wireless communication device with the system clock of the second device based on the first media timestamp, the second media timestamp, the first TOD timestamp, and the second TOD timestamp.

23. The wireless communication device of claim 22, wherein to synchronize the media clock of the wireless communication device with the system clock of the second device, the at least one processor when executing the processor readable code further causes the wireless communication device to measure a timestamp offset and a clock frequency offset between the media clock of the wireless communication device and the system clock of the second device.

24. The wireless communication device of claim 16, wherein the first packet comprises a first fine time measurement (FTM) packet and the second packet comprises a second FTM packet.

25. The wireless communication device of claim 16, wherein the first packet comprises a first data packet and the second packet comprises a second data packet.

26. An wireless communication device comprising:
at least one antenna;
at least one processor; and
at least one memory communicatively coupled with the at least one processor and storing processor readable code that, when executed by the at least one processor, causes the wireless communication device to:
transmit a first packet from the wireless communication device to a second device, the first packet including a first media payload, the first media payload including a first media timestamp associated with the first media payload, the first media timestamp being sampled from a media timestamp incremented by a media clock of the wireless communication device;
capture a first time of departure (TOD) timestamp associated with a transmission time of the first packet, the first TOD timestamp being sampled from a system timestamp incremented by a system clock of the wireless communication device;
embed the first TOD timestamp in a second packet, the second packet including a second media payload, the second media payload including a second media timestamp associated with the second media payload, the second media timestamp being sampled from the media timestamp; and
transmit the second packet from the wireless communication device to the second device.

27. The wireless communication device of claim 26, wherein the at least one processor when executing the processor readable code further causes the wireless communication device to:
capture a second TOD timestamp associated with a transmission time of the second packet, the second TOD timestamp being sampled from the system timestamp incremented by the system clock of the wireless communication device;
embed the second TOD timestamp in a third packet; and
transmit the third packet from the wireless communication device to the second device.

28. The wireless communication device of claim 26, wherein the first packet comprises a first fine time measurement (FTM) packet and the second packet comprises a second FTM packet.

29. The wireless communication device of claim 26, wherein the first packet comprises a first data packet and the second packet comprises a second data packet.

30. The wireless communication device of claim 26, wherein the at least one processor when executing the processor readable code further causes the wireless communication device to:
capture a media transmission timestamp in response to the transmitting of the first packet from the wireless communication device to the second device, the media transmission timestamp being sampled from the media timestamp incremented by the media clock of the wireless communication device;
synchronize the system clock of the wireless communication device with the media clock of the wireless communication device based on the media transmission timestamp and the first TOD timestamp.
